(19) United States
(12) Patent Application Publication
(10) Pub. No.: US 2024/0265928 A1
(43) Pub. Date: Aug. 8, 2024

(54) AUDIO PROCESSING METHOD AND APPARATUS, DEVICE, STORAGE MEDIUM, AND COMPUTER PROGRAM PRODUCT

(71) Applicant: Tencent Technology (Shenzhen) Company Limited, Shenzhen (CN)

(72) Inventors: Meng WANG, Shenzhen (CN); Wei XIAO, Shenzhen (CN); Yuyong KANG, Shenzhen (CN); Qingbo HUANG, Shenzhen (CN); Yupeng SHI, Shenzhen (CN)

(73) Assignee: Tencent Technology (Shenzhen) Company Limited, Shenzhen (CN)

(21) Appl. No.: 18/640,393

(22) Filed: Apr. 19, 2024

Related U.S. Application Data
(63) Continuation of application No. PCT/CN23/90192, filed on Apr. 24, 2023.

(30) Foreign Application Priority Data
Jun. 15, 2022 (CN) 202210681037.X

(51) Int. Cl. G10L 19/008; G10L 19/02; G10L 19/032; G10L 25/30

(52) U.S. Cl. CPC G10L 19/008; G10L 19/0204; G10L 19/032; G10L 25/30

(57) ABSTRACT

An audio processing method/apparatus including performing multichannel signal decomposition on an audio signal to obtain N subband signals of the audio signal, the frequency bands of the N subband signals increase sequentially and N is an integer greater than 2, performing signal compression on each subband signal of the N subband signals to obtain a subband signal feature of each subband signal; and performing quantization encoding on the subband signal feature of each subband signal to obtain a bitstream of each subband signal.

### CROSS-REFERENCE TO RELATED APPLICATIONS

This application is a continuation application of International Application No. PCT/CN2023/090192 filed on Apr. 24, 2023, which claims priority to Chinese Patent Application No. 202210681037.X, filed with the China National Intellectual Property Administration on Jun. 15, 2022, the disclosures of each being incorporated by reference herein in their entireties.

### FIELD

The disclosure relates to the field of data processing technologies, and in particular, to an audio processing method and apparatus, an electronic device, a computer-readable storage medium, and a computer program product.

### BACKGROUND

An audio codec technology is a core technology in a communication service including a remote audio/video call. A speech encoding technology is a technology of using a few network bandwidth resources to transmit speech information as much as possible. From the perspective of Shannon's information theory, speech encoding is a type of source encoding. An objective of the source encoding is to compress, on an encoder side to a maximum extent, an amount of data of information that needs to be transmitted, to eliminate redundancy in the information, and also enable a decoder side to restore the information in a lossless (or approximately lossless) manner.

However, in the related art, in a case that audio quality is guaranteed, audio encoding efficiency is low, or a processing process of audio encoding is complex.

### SUMMARY

Some embodiments provide an audio processing method and apparatus, an electronic device, a computer-readable storage medium, and a computer program product, to improve audio encoding efficiency and reducing audio encoding complexity while ensuring audio quality.

Some embodiments provide an audio processing method, performed by an electronic device, including: performing multichannel signal decomposition on an audio signal to obtain N subband signals of the audio signal, frequency bands of the N subband signals increasing sequentially and N being an integer greater than 2; performing signal compression on each subband signal of the N subband signals to obtain a subband signal feature of each subband signal; and performing quantization encoding on the subband signal feature of each subband signal to obtain a bitstream of each subband signal.

Some embodiments provide an audio processing apparatus, including: at least one memory configured to store program code; and at least one processor configured to read the program code and operate as instructed by the program code, the program code comprising: decomposition code configured to cause at least one of the at least one processor to perform multichannel signal decomposition on an audio signal to obtain N subband signals of the audio signal, frequency bands of the N subband signals increasing sequentially and N being an integer greater than 2; compression code configured to cause at least one of the at least one processor to perform signal compression on each subband signal of the N subband signals to obtain a subband signal feature of each subband signal; and encoding code configured to cause at least one of the at least one processor to perform quantization encoding on the subband signal feature of each subband signal to obtain a bitstream of each subband signal.

Some embodiments provide a non-transitory computer-readable storage medium, storing computer code which, when executed by at least one processor, causes the at least one processor to at least: perform multichannel signal decomposition on an audio signal to obtain N subband signals of the audio signal, frequency bands of the N subband signals increasing sequentially and N being an integer greater than 2; perform signal compression on each subband signal of the N subband signals to obtain a subband signal feature of each subband signal; and perform quantization encoding on the subband signal feature of each subband signal to obtain a bitstream of each subband signal.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of comparison between spectra at different bitrates according to some embodiments.

FIG. 2 is a schematic architectural diagram of an audio codec system according to some embodiments.

FIG. 3A is a schematic structural diagram of an electronic device according to some embodiments.

FIG. 3B is a schematic structural diagram of an electronic device according to some embodiments.

FIG. 4 is a schematic flowchart of an audio processing method according to some embodiments.

FIG. 5 is a schematic flowchart of an audio processing method according to some embodiments.

FIG. 6 is a schematic diagram of an end-to-end speech communication link according to some embodiments.

FIG. 7 is a schematic flowchart of a speech codec method based on subband decomposition and a neural network according to some embodiments.

FIG. 8A is a schematic diagram of filters according to some embodiments.

FIG. 8B is a schematic diagram of a principle of obtaining a four-channel subband signal based on filters according to some embodiments.

FIG. 8C is a schematic diagram of a principle of obtaining a three-channel subband signal based on filters according to some embodiments.

FIG. 9A is a schematic diagram of a common convolutional network according to some embodiments.

FIG. 9B is a schematic diagram of a dilated convolutional network according to some embodiments.

FIG. 10 is a schematic diagram of bandwidth extension according to some embodiments.

FIG. 11 is a diagram of a network structure for channel analysis according to some embodiments.

FIG. 12 shows a network structure for channel synthesis according to some embodiments.

### DESCRIPTION OF EMBODIMENTS

According to some embodiments, an audio signal is decomposed into a plurality of subband signals. In this way, differentiated signal compression can be performed on subband signals. Signal compression is performed on a subband signal, so that feature dimensionality of the subband signal and complexity of signal encoding are reduced. In addition, quantization encoding is performed on a subband signal feature with reduced feature dimensionality. This improves audio encoding efficiency while ensuring audio quality.

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following descriptions, the terms “first” and “second” are merely intended to distinguish between similar objects rather than describe a specific order of objects. It can be understood that the “first” and the “second” are interchangeable in order in proper circumstances, so that embodiments described herein can be implemented in an order other than the order illustrated or described herein.

Unless otherwise defined, meanings of all technical and scientific terms used in the disclosure are the same as those usually understood by a person skilled in the art to which the disclosure belongs. The terms used in the disclosure are merely intended to describe the objectives of some embodiments, but are not intended to be limiting.

Before some embodiments are described in detail, terms in the embodiments are described, and the following explanations are applicable to the terms.

(1) Neural network (NN): an algorithmic mathematical model that imitates behavioral characteristics of an animal neural network to perform distributed parallel information processing. Depending on system complexity, this type of network adjusts an interconnection relationship between a large number of internal nodes to process information.

(2) Deep learning (DL): a new research direction in the machine learning (ML) field. Deep learning is to learn inherent laws and representation levels of sample data. Information obtained during these learning processes is quite helpful in interpretations of data such as text, images, and sound. An ultimate goal is to enable a machine to have the same analytic learning ability as humans and be able to recognize data such as text, images, and sound.

(3) Quantization: a process of approximating continuous values (or a large number of discrete values) of a signal to a limited number of (or a few) discrete values. Quantization includes vector quantization (VQ) and scalar quantization.

The vector quantization is an effective lossy compression technology based on Shannon's rate distortion theory. A basic principle of the vector quantization is to use an index of a code word, in a code book, that best matches an input vector to replace the input vector for transmission and storage, and only a simple table lookup operation is required during decoding. For example, several pieces of scalar data constitute a vector space. The vector space is divided into several small regions. For a vector falling into a small region during quantization, a corresponding index is used to replace the input vector.

The scalar quantization is quantization on scalars, that is, one-dimensional vector quantization. A dynamic rang is divided into several intervals, and each interval has a representative value (namely, an index). When an input signal falls into an interval, the input signal is quantized into the representative value.

(4) Entropy encoding: a lossless encoding scheme in which no information is lost during encoding according to a principle of entropy, and also a key module in lossy encoding. Entropy encoding is performed at the end of an encoder. The entropy encoding includes Shannon encoding, Huffman encoding, exponential-Golomb (Exp-Golomb) encoding, and arithmetic encoding.

(5) Quadrature mirror filters (QMF): a filter pair including analysis-synthesis. QMF analysis filters are used for subband signal decomposition to reduce signal bandwidth, so that each subband signal can be processed properly a respective channel. QMF synthesis filters are used for synthesis of subband signals recovered from a decoder side, for example, reconstructing an original audio signal through zero-value interpolation, bandpass filtering, or the like.

A speech encoding technology is a technology of using a few network bandwidth resources to transmit speech information as much as possible. A compression ratio of a speech codec can reach more than 10 times. In some embodiments, after original 10-MB speech data is compressed by an encoder, only 1 MB needs to be transmitted. This greatly reduces bandwidth resources required for transmitting information. For example, for a wideband speech signal with a sampling rate of 16,000 Hz, if a sampling depth is 16 bits, precision for recording speech intensity during sampling, a bitrate (an amount of data transmitted per unit time) of an uncompressed version is 256 kbps. If the speech encoding technology is used, even in the case of lossy encoding, quality of a reconstructed speech signal can be close to that of the uncompressed version within a bitrate range of 10-20 kbps, even without a difference in the sense of hearing. If a service with a higher sample rate is required, for example, 32000-Hz ultra-wideband speech, a bitrate range needs to reach at least 30 kbps.

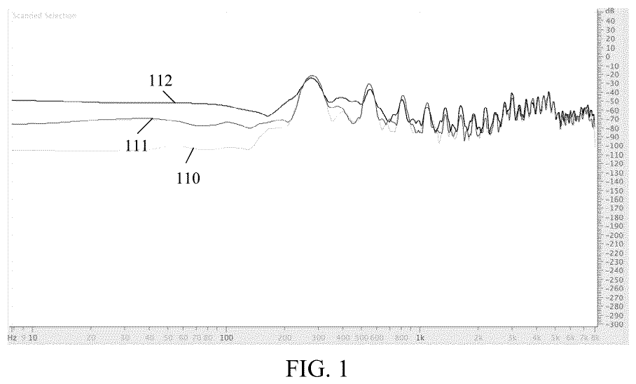

In a communications system, to ensure proper communication, standard speech codec protocols are deployed in the industry, for example, standards from the ITU Telecommunication Standardization Sector (ITU-T), 3rd Generation Partnership Project (3GPP), Internet Engineering Task Force (IETF), Audio and Video Coding Standard (AVS), China Communications Standards Association (CCSA), and other standards organizations in and outside China, G.711, G.722, AMR series, EVS, OPUS, and other standards. FIG. 1 is a schematic diagram of comparison between spectra at different bitrates to illustrate a relationship between a compression bitrate and quality. A curve 110 is a spectral curve for original speech, namely, an uncompressed signal. A curve 111 is a spectral curve for an OPUS encoder at a bitrate of 20 kbps. A curve 112 is a spectral curve for OPUS encoding at a bitrate of 6 kbps. It can be learned from FIG. 1 that a compressed signal is closer to an original signal with an increase of an encoding bitrate.

A principle of speech encoding in the related art is generally as follows: During speech encoding, speech waveform samples can be directly encoded sample by sample. Related low-dimensionality features are extracted according to a vocalism principle of humans, an encoder encodes these features, and a decoder reconstructs a speech signal based on these parameters.

The foregoing encoding principles are derived from speech signal modeling, namely, a compression method based on signal processing. Compared with the compression method based on signal processing, to improve encoding efficiency while ensuring speech quality, embodiments of the disclosure provide an audio processing method and apparatus, an electronic device, a computer-readable storage medium, and a computer program product, to improve encoding efficiency. The following describes the electronic device provided in some embodiments. The electronic device provided in some embodiments may be implemented by a terminal device or a server or jointly implemented by a terminal device and a server. An example in which the electronic device is implemented by a terminal device is used for description.

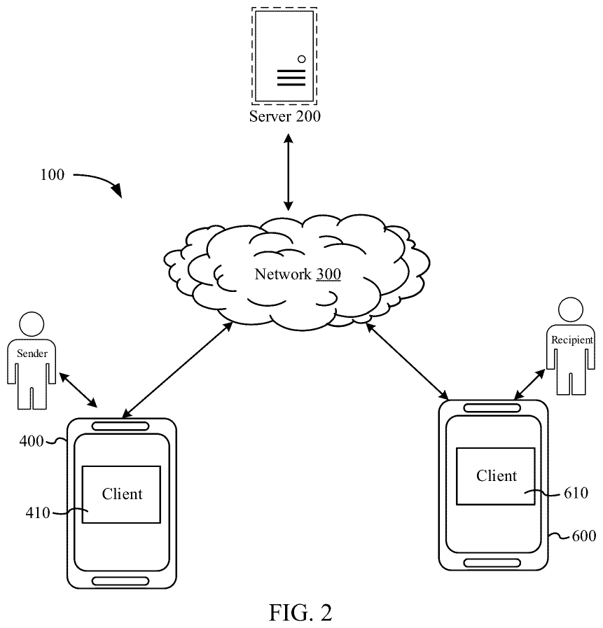

For example, FIG. 2 is a schematic architectural diagram of an audio codec system 100 according to some embodiments. The audio codec system 100 includes: a server 200, a network 300, a terminal device 400 (namely, an encoder side), and a terminal device 600 (namely, a decoder side). The network 300 may be a local area network, a wide area network, or a combination thereof.

In some embodiments, a client 410 runs on the terminal device 400, and the client 410 may be various types of clients, for example, an instant messaging client, a web conferencing client, a livestreaming client, or a browser. In response to an audio capture instruction triggered by a sender (for example, an initiator of a network conference, an anchor, or an initiator of a voice call), the client 410 calls a microphone of the terminal device 400 to capture an audio signal, and encodes the captured audio signal to obtain a bitstream.

For example, the client 410 calls the audio processing method provided in some embodiments to encode the captured audio signal, and perform the following operations: performing multichannel signal decomposition on the audio signal to obtain N subband signals of the audio signal; performing signal compression on each subband signal to obtain a subband signal feature of each subband signal; and performing quantization encoding on the subband signal feature of each subband signal to obtain a bitstream of each subband signal.

The client 410 may transmit the bitstreams (namely, the low-frequency bitstream and the high-frequency bitstream) to the server 200 through the network 300, so that the server 200 transmits the bitstreams to the terminal device 600 associated with a recipient (for example, a participant of the network conference, an audience, or a recipient of the voice call).

After receiving the bitstreams transmitted by the server 200, a client 610 (for example, an instant messaging client, a web conferencing client, a livestreaming client, or a browser) may decode the bitstreams to obtain the audio signal, to implement audio communication.

For example, the client 610 calls the audio processing method provided in some embodiments to decode the received bitstreams, and perform the following operations: performing quantization decoding on N bitstreams to obtain a subband signal feature corresponding to each bitstream; performing signal decompression on each subband signal feature to obtain an estimated subband signal corresponding to each subband signal feature; and performing signal synthesis on a plurality of estimated subband signals to obtain a decoded audio signal.

Some embodiments may be implemented by using a cloud technology. The cloud technology is a hosting technology that integrates a series of resources such as hardware, software, and network resources in a wide area network or a local area network implement data computing, storage, processing, and sharing.

The cloud technology is a general term for a network technology, an information technology, an integration technology, a management platform technology, an application technology, and the like that are based on application of a cloud computing business model, and may constitute a resource pool for use on demand and therefore is flexible and convenient. A cloud computing technology is to become an important support. A function of service interaction between servers 200 may be implemented by using a cloud technology.

For example, the server 200 shown in FIG. 2 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device 400 and the terminal device 600 shown in FIG. 2 each may be a smartphone, a tablet computer, a notebook computer, a desktop computer, a smart speaker, a smartwatch, a vehicle-mounted terminal, or the like, but is not limited thereto. The terminal device (for example, the terminal device 400 and the terminal device 600) and the server 200 may be directly or indirectly connected in a wired or wireless communication mode. This is not limited thereto.

In some embodiments, the terminal device or the server 200 may implement the audio processing method by running a computer program. For example, the computer program may be a native program or software module in an operating system. The computer program may be a native application (APP), in some embodiments, a program that needs to be installed in an operating system to run, for example, a livestreaming APP, a web conferencing APP, or an instant messaging APP; or may be a mini program, in some embodiments, a program that only needs to be downloaded to a browser environment to run; or may be a mini program that can be embedded in any APP. To sum up, the computer program may be an application, a module, or a plug-in in any form.

In some embodiments, a plurality of servers may constitute a blockchain, and the server 200 is a node in the blockchain. There may be an information connection between nodes in the blockchain, and information may be transmitted between nodes through the information connection. Data (for example, logic and bitstreams of audio processing) related to the audio processing method provided in some embodiments may be stored in the blockchain.

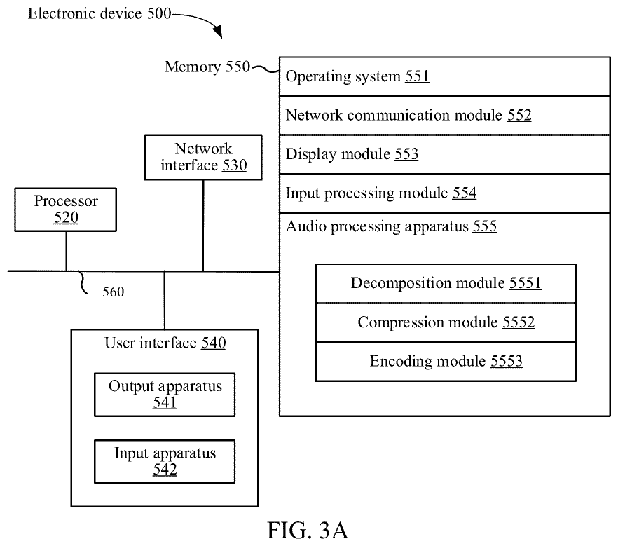

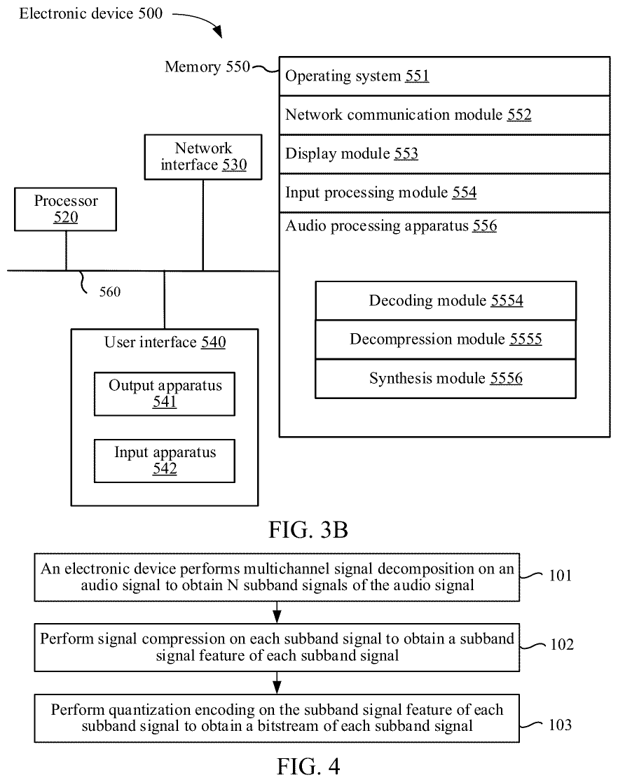

FIG. 3A and FIG. 3B are schematic structural diagrams of an electronic device 500 according to some embodiments. An example in which the electronic device 500 is a terminal device is used for description. The electronic device 500 shown in FIG. 3A and FIG. 3B includes at least one processor 520, a memory 550, at least one network interface 530, and a user interface 540. The components in the electronic device 500 are coupled together through a bus system 560. It may be understood that, the bus system 560 is configured to implement connection and communication between the components. In addition to a data bus, the bus system 560 further includes a power bus, a control bus, and a state signal bus. However, for ease of clear description, all types of buses in FIG. 3A and FIG. 3B are marked as the bus system 560.

The processor 520 may be an integrated circuit chip with a signal processing capability, for example, a general-purpose processor, a digital signal processor (DSP), another programmable logic device, a discrete gate or transistor logic device, or a discrete hardware component. The general-purpose processor may be a microprocessor, any conventional processor, or the like.

The user interface 540 includes one or more output apparatuses 541 capable of displaying media content, including one or more speakers and/or one or more visual display screens. The user interface 540 further includes one or more input apparatuses 542, including user interface components for facilitating user input, for example, a keyboard, a mouse, a microphone, a touch display screen, a camera, or another input button or control.

The memory 550 may be a removable memory, a non-removable memory, or a combination thereof. Exemplary hardware devices include a solid-state memory, a hard disk drive, an optical disc drive, and the like. In some embodiments, the memory 550 includes one or more storage devices physically located away from the processor 520.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described herein is intended to include any suitable type of memory.

In some embodiments, the memory 550 is capable of storing data to support various operations. Examples of the data include a program, a module, and a data structure or a subset or superset thereof. Examples are described below:
an operating system 551, including system programs configured for processing various basic system services and performing hardware-related tasks, for example, a framework layer, a core library layer, and a driver layer for implementing various basic services and processing hardware-based tasks;
a network communication module 552, configured to reach another computing device through one or more (wired or wireless) network interfaces 530, exemplary network interfaces 530 including Bluetooth, wireless fidelity (Wi-Fi), universal serial bus (USB), and the like;
a display module 553, configured to display information by using one or more output apparatuses 541 (for example, a display screen or a speaker) associated with the user interface 540 (for example, a user interface for operating a peripheral device and displaying content and information); and
an input processing module 554, configured to detect one or more user inputs or interactions from one or more input apparatuses 542 and translate the detected inputs or interactions.

In some embodiments, an audio processing apparatus may be implemented by using software. FIG. 3A and FIG. 3B each show an audio processing apparatus stored in the memory 550. The audio processing apparatus may be software in the form of a program or a plug-in. An audio processing apparatus 555 is configured to implement an audio encoding function, and includes the following software modules: a decomposition module 5551, a compression module 5552, and an encoding module 5553. An audio processing apparatus 556 is configured to implement an audio decoding function, and includes the following software modules: a decoding module 5554, a decompression module 5555, and a synthesis module 5556. The modules in the audio processing apparatus are logical modules, and therefore may be flexibly combined or split based on an implemented function.

As described above, the audio processing method may be implemented by various types of electronic devices (for example, a terminal or a server). FIG. 4 is a schematic flowchart of an audio processing method according to some embodiments. An audio encoding function is implemented through audio processing. Descriptions are provided below with reference to operations shown in FIG. 4.

In operation 101, an electronic device performs multichannel signal decomposition on an audio signal to obtain N subband signals of the audio signal,
N is an integer greater than 2, and frequency bands of the N subband signals increase sequentially.

The N subband signals herein exist in the form of a subband signal sequence. In some embodiments, the N subband signals of the audio signal have a specific order. The order is the first subband signal, the second subband signal, . . . , and an N^{th} subband signal. In the subband signal sequence, one of two adjacent subband signals that is sort behind has a greater frequency band than that of the one sort in front. In other words, the frequency bands of the N subband signals in the subband signal sequence increase sequentially.

In some embodiments, obtaining the audio signal may comprise: an encoder side responds to an audio capture instruction triggered by a sender (for example, an initiator of a network conference, an anchor, or an initiator of a voice call), and calls a microphone of a terminal device on the encoder side to capture an audio signal to obtain the audio signal (also referred to as an input signal).

After the audio signal is obtained, the audio signal is decomposed into a plurality of subband signals. Because a low-frequency subband signal among the subband signals has greater impact on audio encoding, differentiated signal processing is subsequently performed on the subband signals.

In some embodiments, the multichannel signal decomposition is implemented through multi-layer two-channel subband decomposition; and the performing multichannel signal decomposition on an audio signal to obtain N subband signals of the audio signal includes: performing first-layer two-channel subband decomposition on the audio signal to obtain a first-layer low-frequency subband signal and a first-layer high-frequency subband signal; performing an (i+1)^{th}-layer two-channel subband decomposition on an i^{th}-layer subband signal to obtain an (i+1)^{th}-layer low-frequency subband signal and an (i+1)^{th}-layer high-frequency subband signal, the i^{th}-layer subband signal being an i^{th}-layer low-frequency subband signal, or the i^{th}-layer subband signal being an i^{th}-layer high-frequency subband signal and an i^{th}-layer low-frequency subband signal, and i being an increasing natural number with a value range of 1≤i<N; and using a last-layer subband signal and a high-frequency subband signal at each layer that has not undergone the two-channel subband decomposition as subband signals of the audio signal. In some embodiments, the following processing is performed through iteration of i to implement the multichannel signal decomposition on the audio signal: performing an (i+1)^{th}-layer two-channel subband decomposition on an i^{th}-layer subband signal to obtain an (i+1)^{th}-layer low-frequency subband signal and an (i+1)^{th}-layer high-frequency subband signal.

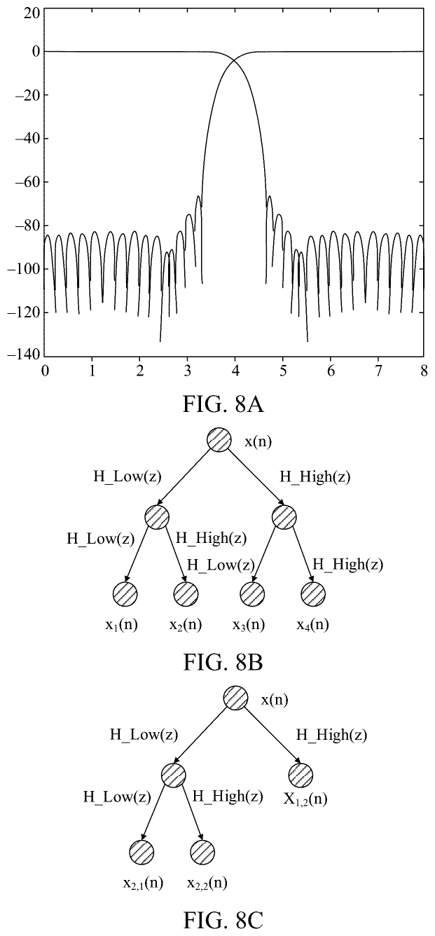

The subband signal includes a plurality of sample points obtained by sampling the audio signal. As shown in FIG. 8B, the audio signal passes through a two-channel QMF analysis filter with two layers of iterations. In some embodiments, two-channel subband decomposition with two layers of iterations is performed on the audio signal to obtain a four-channel subband signal (xₖ(n), n=1, 2, 3, 4). In some embodiments, first-layer two-channel subband decomposition is performed on the audio signal to obtain a first-layer low-frequency subband signal and a first-layer high-frequency subband signal; second-layer two-channel subband decomposition is performed on the first-layer low-frequency subband signal to obtain a second-layer low-frequency subband signal x₁(n) of the first-layer low-frequency subband signal and a second-layer high-frequency subband signal x₂(n) of the first-layer low-frequency subband signal; and second-layer two-channel subband decomposition is performed on the first-layer high-frequency subband signal to obtain a second-layer low-frequency subband signal x₃(n) of the first-layer high-frequency subband signal and a second-layer high-frequency subband signal x₄(n) of the first-layer high-frequency subband signal, so that the four-channel subband signal xₖ(n), n=1, 2, 3, 4 is obtained.

As shown in FIG. 8C, the audio signal passes through a two-channel QMF analysis filter with two layers of iterations. In some embodiments, two-channel subband decomposition with two layers of iterations is performed on the audio signal to obtain a three-channel subband signal (x_{2,1}(n), x_{2,2}(n), x_{1,2}(n)). In some embodiments, first-layer two-channel subband decomposition is performed on the audio signal to obtain a first-layer low-frequency subband signal and a first-layer high-frequency subband signal x_{1,2}(n); second-layer two-channel subband decomposition is performed on the first-layer low-frequency subband signal to obtain a second-layer low-frequency subband signal x_{2,1}(n) of the first-layer low-frequency subband signal and a second-layer high-frequency subband signal x_{2,2}(n) of the first-layer low-frequency subband signal; and no two-channel subband decomposition is performed on the first-layer high-frequency subband signal x_{1,2}(n), so that the three-channel subband signal x_{2,1}(n), x_{2,2}(n), x_{1,2}(n) is obtained.

In some embodiments, the performing first-layer two-channel subband decomposition on the audio signal to obtain the first-layer low-frequency subband signal and the first-layer high-frequency subband signal includes: sampling the audio signal to obtain a sampled signal, the sampled signal including a plurality of sample points obtained through sampling; performing first-layer low-pass filtering on the sampled signal to obtain a first-layer low-pass filtered signal; downsampling the first-layer low-pass filtered signal to obtain the first-layer low-frequency subband signal; performing first-layer high-pass filtering on the sampled signal to obtain a first-layer high-pass filtered signal; and downsampling the first-layer high-pass filtered signal to obtain the first-layer high-frequency subband signal.

The audio signal is a continuous analog signal, the sampled signal is a discrete digital signal, and the sample point is a sampled value obtained from the audio signal through sampling.

In some embodiments, for example, the audio signal is an input signal with a sampling rate Fs of 32,000 Hz. The audio signal is sampled to obtain a sampled signal x(n) including 640 sample points. An analysis filter (two channels) of QMF filters is called to perform low-pass filtering on the sampled signal to obtain a low-pass filtered signal, perform high-pass filtering on the sampled signal to obtain a high-pass filtered signal, downsample the low-pass filtered signal to obtain a first-layer low-frequency subband signal x_{LB}(n), and downsample the high-pass filtered signal to obtain a first-layer high-frequency subband signal. Effective bandwidth for x_{LB}(n) and x_{HB}(n) is 0-8 kHz and 8-16 kHz respectively. x_{LB}(n) and x_{HB}(n) each have 320 sample points.

The QMF filters are a filter pair that includes analysis and synthesis. For the QMF analysis filter, an input signal with a sampling rate of Fs may be decomposed into two signals with a sampling rate of Fs/2, which represent a QMF low-pass signal and a QMF high-pass signal respectively. A reconstructed signal, with a sampling rate of Fs, that corresponds to the input signal may be restored through synthesis performed by a QMF synthesis filter on a low-pass signal and a high-pass signal that are restored on a decoder side.

In some embodiments, the performing multichannel signal decomposition on the audio signal to obtain the N subband signals of the audio signal includes: sampling the audio signal to obtain a sampled signal, the sampled signal including a plurality of sample points obtained through sampling; performing j^{th}-channel filtering on the sampled signal to obtain a j^{th} filtered signal; and downsampling the j^{th} filtered signal to obtain a j^{th} subband signal of the audio signal, j is an increasing natural number with a value range of 1≤j≤N. In some embodiments, each channel in the sampled signal is filtered through iteration of j to obtain a corresponding filtered signal, and then the filtered signal is downsampled to obtain a subband signal, so that multichannel signal decomposition on the audio signal is completed.

For example, QMF analysis filters may be preconfigured in a multichannel mode. j^{th}-channel filtering is performed on the sampled signal through a filter of a j^{th} channel to obtain the j^{th} filtered signal, and the j^{th} filtered signal is downsampled to obtain the j^{th} subband signal of the audio signal.

In operation 102, signal compression is performed on each subband signal to obtain a subband signal feature of each subband signal.

Herein, signal compression is performed on each subband signal to obtain the subband signal feature of each subband signal, and the signal compression result is used as a subband signal feature of a corresponding subband signal.

Feature dimensionality of the subband signal feature of each subband signal is not positively correlated with a frequency band of the subband signal, and feature dimensionality of a subband signal feature of an N^{th} subband signal is lower than that of a subband signal feature of the first subband signal. The being not positively correlated means that the feature dimensionality of the subband signal feature decreases or remains unchanged with an increase of the frequency band of the subband signal. In some embodiments, feature dimensionality of a subband signal feature is less than or equal to that of a previous subband signal feature. Data compression may be performed on the subband signal through signal compression (namely, channel analysis), to reduce an amount of data of the subband signal. In some embodiments, dimensionality of the subband signal feature of the subband signal is lower than that of the subband signal.

In some embodiments, because a subband signal with a lower frequency has greater impact on audio encoding, the N subband signals may be classified, and then differentiated signal compression (namely, encoding) may be performed on different types of subband signals. For example, the N subband signals are divided into two types: a high-frequency type and a low-frequency type. Then signal compression is performed on the high-frequency subband signal in a first manner, and signal compression is performed on the low-frequency subband signal in a second manner, the first manner being different from the second manner. Differentiated signal processing is performed on the subband signals, so that feature dimensionality of a subband signal feature of a higher-frequency subband signal is lower.

In some embodiments, the performing signal compression on each subband signal to obtain the subband signal feature of each subband signal includes: performing the following processing on each subband signal: calling a first neural network model corresponding to the subband signal; and performing feature extraction on the subband signal through the first neural network model to obtain the subband signal feature of the subband signal, structural complexity of the first neural network model being positively correlated with dimensionality of the subband signal feature of the subband signal.

In some embodiments, for example, feature extraction may be performed on the subband signal through the first neural network model to obtain the subband signal feature, to minimize feature dimensionality of the subband signal feature while ensuring integrity of the subband signal feature. A structure of the first neural network model is not limited herein.

In some embodiments, the performing feature extraction on the subband signal through the first neural network model to obtain the subband signal feature of the subband signal includes: performing the following processing on the subband signal through the first neural network model: performing convolution on the subband signal to obtain a convolution feature of the subband signal; performing pooling on the convolution feature to obtain a pooling feature of the subband signal; downsampling the pooling feature to obtain a downsampling feature of the subband signal; and performing convolution on the downsampling feature to obtain the subband signal feature of the subband signal.

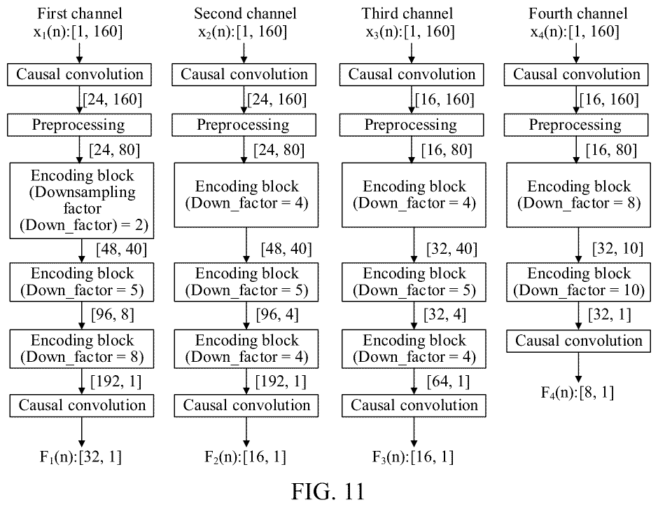

As shown in FIG. 11, a first-channel neural network model is called based on the subband signal x₁(n) to generate a feature vector F₁(n) with lower dimensionality, namely, the subband signal feature. First, convolution is performed on the input subband signal x₁(n) through causal convolution to obtain a 24×160 convolution feature. Then pooling (namely, preprocessing) with a factor of 2 is performed on the 24×160 convolution feature to obtain a 24×80 pooling feature. Then the 24×80 pooling feature is downsampled to obtain a 192×1 downsampling feature. Finally, convolution is performed on the 192×1 downsampling feature through causal convolution again to obtain a 32-dimensional feature vector F₁(n).

In some embodiments, the downsampling is implemented through a plurality of concatenated encoding layers; and the downsampling the pooling feature to obtain the downsampling feature of the subband signal includes: downsampling the pooling feature through the first encoding layer of the plurality of concatenated encoding layers; outputting a downsampling result of the first encoding layer to a subsequent concatenated encoding layer, and continuing to perform downsampling and output a downsampling result through the subsequent concatenated encoding layer, until the last encoding layer performs output; and using a downsampling result outputted by the last encoding layer as the downsampling feature of the subband signal.

As shown in FIG. 11, the pooling feature is downsampled through three concatenated encoding blocks (namely, encoding layers) with different downsampling factors (Down_factor). In some embodiments, the 24×80 pooling feature is first downsampled through an encoding block with a Down_factor of 2 to obtain a 48×40 downsampling result. Then the 48×40 downsampling result is downsampled through an encoding block with a Down_factor of 5 to obtain a 96×8 downsampling results. Finally, the 96×8 downsampling result is downsampled through an encoding block with a Down_factor of 8 to obtain the 192×1 downsampling feature. The encoding block with a Down_factor of 4 is used as an example. One or more dilated convolutions may be first performed, and pooling is performed based on the Down_factor to implement a function of downsampling.

Each time processing is performed through an encoding layer, an understanding of the neural network model on the downsampling feature is further deepened. When learning is performed through a plurality of encoding layers, the downsampling feature of the low-frequency subband signals can be accurately learned step by step. The downsampling feature of the low-frequency subband signal with progressive precision can be obtained through concatenated encoding layers.

In some embodiments, the performing signal compression on each subband signal to obtain the subband signal feature of each subband signal includes: separately performing feature extraction on the first k subband signals of the N subband signals (namely, the subband signal sequence) to obtain subband signal features respectively corresponding to the first k subband signals; and separately performing bandwidth extension on the last N−k subband signals of the N subband signals to obtain subband signal features respectively corresponding to the last N−k subband signals, k being an integer within a value range of 1<k<N.

k is a multiple of 2. Because a subband signal with a lower frequency has greater impact on audio encoding, differentiated signal processing is performed on the subband signals, and a subband signal with a higher frequency is compressed to a larger extent. In some embodiments, the subband signal is compressed by using another method: bandwidth extension (a wideband speech signal is restored from a narrowband speech signal with a limited frequency band), to quickly compress the subband signal and extract a high-frequency feature of the subband signal. The high-frequency bandwidth extension is intended to reduce dimensionality of the subband signal and implement a function of data compression.

In some embodiments, a QMF analysis filter (two-channel QMF) is called for downsampling. As shown in FIG. 8C, three-channel decomposition is implemented through the QMF analysis filter, and finally, three subband signals can be obtained: x_{HB}(n), x_{2,1}(n), and x_{2,2}(n). As shown in FIG. 8C, x_{2,1}(n) and x_{2,2}(n) correspond to a spectrum of 0-4 kHz and a spectrum of 4-8 kHz respectively, and are generated by a two-channel QMF analysis filter with two iterations and are equivalent to x₁(n) and x₂(n) in the first implementation. These two subband signals x_{2,1}(n) and x_{2,2}(n) each include 160 sample points. As shown in FIG. 8C, for a frequency band of 8-16 kHz frequency band, detailed analysis is not required. Therefore, a high-frequency subband signal x_{HB}(n) can be generated by QMF high-pass filtering needs to be performed on an input only once of the original 32 kHz sampled input signal, and each frame includes 320 sample points.

A neural network model (a first channel and a second channel in FIG. 11) may be called to perform feature extraction on two subband signals corresponding to x_{2,1}(n) and x_{2,2}(n). As a result, feature vectors F₁(n) and F₂(n) corresponding to the subband signals are generated, with a dimensionality of 32 and a dimensionality of 16 respectively. For the high-frequency subband signal x_{HB}(n) including 320 points, a feature vector FHB(n) corresponding to the subband signal is generated through bandwidth extension.

In some embodiments, the separately performing bandwidth extension on the last N−k subband signals to obtain the subband signal features respectively corresponding to the last N−k subband signals includes: performing the following processing on each of the last N−k subband signals: performing frequency domain transform based on a plurality of sample points included in the subband signal to obtain transform coefficients respectively corresponding to the plurality of sample points; dividing the transform coefficients respectively corresponding to the plurality of sample points into a plurality of subbands; performing mean processing on a transform coefficient included in each subband to obtain average energy corresponding to each subband, and using the average energy as a subband spectral envelope corresponding to each subband; and determining subband spectral envelopes respectively corresponding to the plurality of subbands as the subband signal feature corresponding to the subband signal.

A frequency domain transform method in some embodiments includes modified discrete cosine transform (MDCT), discrete cosine transform (DCT), and fast Fourier transform (FFT). A frequency domain transform manner is not limited herein. The mean processing in some embodiments includes an arithmetic mean and a geometric mean. A manner of mean processing is not limited herein.

In some embodiments, the performing frequency domain transform based on the plurality of sample points included in the subband signal to obtain the transform coefficients respectively corresponding to the plurality of sample points includes: obtaining a reference subband signal of a reference audio signal, the reference audio signal being an audio signal adjacent to the audio signal, and a frequency band of the reference subband signal being the same as that of the subband signal; and performing, based on a plurality of sample points included in the reference high-frequency subband signal and the plurality of sample points included in the high-frequency subband signal, discrete cosine transform on the plurality of sample points included in the high-frequency subband signal to obtain the transform coefficients respectively corresponding to the plurality of sample points included in the high-frequency subband signal.

In some embodiments, a process of performing geometric mean processing on the transform coefficients included in each subband is as follows: A sum of squares of transform coefficients corresponding to sample points included in each subband is determined; and a ratio of the sum of squares to a quantity of sample points included in the subband is determined as the average energy corresponding to each subband.

In some embodiments, for example, the modified discrete cosine transform (MDCT) is called for the high-frequency subband signal x_{HB}(n) including 320 points to generate MDCT coefficients for the 320 points (namely, the transform coefficients respectively corresponding to the plurality of sample points included in the high-frequency subband signal). Specifically, in the case of 50% overlapping, an (n+1)^{th} frame of high-frequency data (namely, the reference audio signal) and an n^{th} frame of high-frequency data (namely, the audio signal) may be combined (spliced), and MDCT is performed for 640 points to obtain the MDCT coefficients for the 320 points.

The MDCT coefficients for the 320 points are divided into N subbands (that is, the transform coefficients respectively corresponding to the plurality of sample points are divided into a plurality of subbands). The subband herein combines a plurality of adjacent MDCT coefficients into a group, and the MDCT coefficients for the 320 points may be divided into eight subbands. For example, the 320 points may be evenly allocated, in other words, each subband includes a same quantity of points. In some embodiments, the 320 points may be divided unevenly. For example, a lower-frequency subband includes fewer MDCT coefficients (with a higher frequency resolution), and a higher-frequency subband includes more MDCT coefficients (with a lower frequency resolution).

According to the Nyquist sampling theorem (to restore an original signal from a sampled signal without distortion, a sampling frequency needs to be greater than 2 times the highest frequency of the original signal, and when a sampling frequency is less than 2 times the highest frequency of a spectrum, spectra of signals overlap, or when a sampling frequency is greater than 2 times the highest frequency of the spectrum, spectra of signals do not overlap), the MDCT coefficients for the 320 points represent a spectrum of 8-16 kHz. However, UWB speech communication does not necessarily require a spectrum of 16 kHz. For example, if a spectrum is set to 14 kHz, only MDCT coefficients for the first 240 points need to be considered, and correspondingly, a quantity of subbands may be controlled to be 6.

For each subband, average energy of all MDCT coefficients in the current subband is calculated (that is, mean processing is performed on transform coefficients included in each subband) as a subband spectral envelope (the spectral envelope is a smooth curve passing through principal peak points of a spectrum). For example, the MDCT coefficients included in the current subband are x(n), where n=1, 2, . . . , 40. In this case, average energy is calculated by using a geometric mean: Y=((x(1)²+x(2)²+ . . . +x(40)²)/40). In a case that the MDCT coefficients for the 320 points are divided into eight subbands, eight subband spectral envelopes may be obtained. The eight subband spectral envelopes are a generated feature vector FHB(n), namely, the high-frequency feature, of the high-frequency subband signal.

In operation 103, quantization encoding is performed on the subband signal feature of each subband signal to obtain a bitstream of each subband signal.

In some embodiments, for example, differentiated signal processing is performed on the subband signals, so that feature dimensionality of a subband signal feature of a higher-frequency subband signal is lower. Quantization encoding is performed on a subband signal feature with reduced feature dimensionality, and the bitstream is transmitted to the decoder side, so that the decoder side decodes the bitstream to restore the audio signal. This improves audio encoding efficiency while ensuring audio quality.

In some embodiments, the performing quantization encoding on the subband signal feature of each subband signal to obtain the bitstream of each subband signal includes: quantizing the subband signal feature of each subband signal to obtain an index value of the subband signal feature; and performing entropy encoding on the index value of the subband signal feature to obtain a bitstream of the subband signal.

For example in some embodiments, scalar quantization (each component is quantized separately) and entropy encoding may be performed on the subband signal feature of the subband signal. In addition, a combination of the vector quantization (a plurality of adjacent components are combined into a vector for joint quantization) and entropy encoding technologies is not limited herein. An encoded bitstream is transmitted to the decoder side, and the decoder side decodes the bitstream.

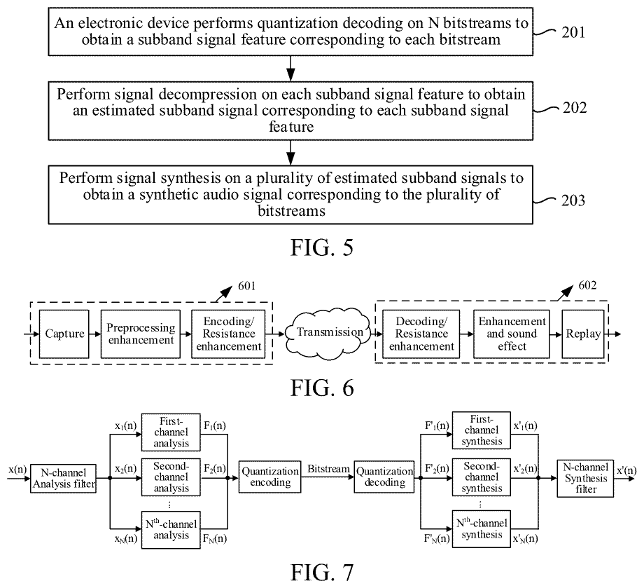

As described above, the audio processing method provided in some embodiments may be implemented by various types of electronic devices. FIG. 5 is a schematic flowchart of an audio processing method according to some embodiments. An audio decoding function is implemented through audio processing. Descriptions are provided below with reference to operations shown in FIG. 5.

In operation 201, the electronic device performs quantization decoding on N bitstreams to obtain a subband signal feature corresponding to each bitstream.

N is an integer greater than 2. The N bitstreams are obtained by encoding N subband signals respectively. The N subband signals are obtained by performing multichannel signal decomposition on the audio signal.

For example in some embodiments, after the bitstream of the subband signal is obtained through encoding by using the audio processing method shown in FIG. 4, the encoded bitstream of the subband signal is transmitted to a decoder side. After receiving the bitstream of the subband signal, the decoder side performs quantization decoding on the bitstream of the subband signal to obtain the subband signal feature corresponding to the bitstream.

The quantization decoding is an inverse process of quantization encoding. In a case that a bitstream is received, entropy decoding is first performed. Through lockup of a quantization table (in some embodiments, inverse quantization is performed, where the quantization table is a mapping table generated through quantization during encoding), a subband signal feature is obtained. A process of decoding the received bitstream by the decoder side is an inverse process of an encoding process on an encoder side. Therefore, a value generated during decoding is an estimated value relative to a value obtained during encoding. For example, the subband signal feature generated during decoding is an estimated value relative to a subband signal feature obtained during encoding.

In some embodiments, for example, the performing quantization decoding on the N bitstreams to obtain the subband signal feature corresponding to each bitstream includes: performing the following processing on each of the N bitstreams: performing entropy decoding on the bitstream to obtain an index value corresponding to the bitstream; and performing inverse quantization on the index value corresponding to the bitstream to obtain the subband signal feature corresponding to the bitstream.

In operation 202, signal decompression is performed on each subband signal feature to obtain an estimated subband signal corresponding to each subband signal feature.

For example, the signal decompression (also referred to as channel synthesis) is an inverse process of signal compression. Signal decompression is performed on the subband signal feature to obtain the estimated subband signal corresponding to each subband signal feature.

In some embodiments, the performing signal decompression on each subband signal feature to obtain the estimated subband signal corresponding to each subband signal feature includes: performing the following processing on each subband signal feature: calling a second neural network model corresponding to the subband signal feature; and performing feature reconstruction on the subband signal feature through the second neural network model to obtain an estimated subband signal corresponding to the subband signal feature, structural complexity of the second neural network model being positively correlated with dimensionality of the subband signal feature.

For example, in a case that the encoder side performs feature extraction on all subband signal to obtain subband signal features, the decoder side performs feature reconstruction on the subband signal features to obtain a high-frequency subband signal corresponding to a high-frequency feature.

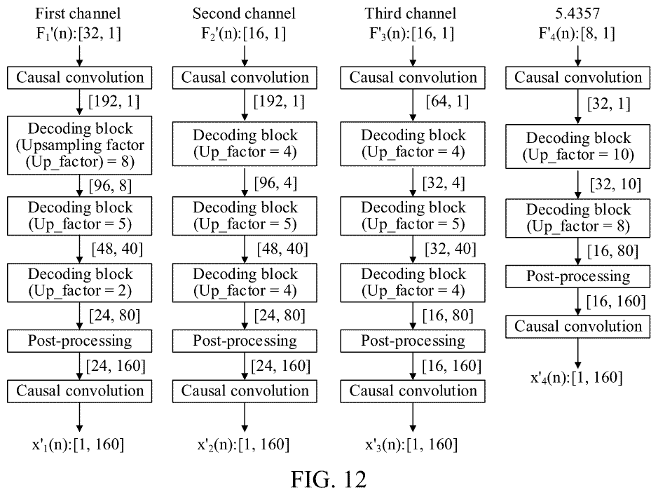

In some embodiments, when receiving four bitstreams, the decoder side performs quantization decoding on the four bitstreams to obtain estimated values F′ₖ(n), k=1, 2, 3, 4 of subband signal vectors (namely, feature vectors) in four channels. Based on the estimated values F′ₖ(n), k=1, 2, 3, 4 of the feature vectors, a deep neural network (as shown in FIG. 12) is called to generate an estimated value x′ₖ(n), k=1, 2, 3, 4 of a subband signal, namely, an estimated subband signal.

As shown in FIG. 12, a flowchart of a network structure for signal compression is similar to that of a network structure for signal decompression. In some embodiments, for example, a post-processing structure in a network structure for causal convolution and signal decompression is similar to a preprocessing structure in the network structure for signal compression. A structure of a decoding block is symmetric with that of an encoding block on the encoder side. For the encoding block on the encoder side, dilated convolution is first perform, and then pooling and downsampling are performed. For the decoding block on the decoder side, pooling is first performed, and then upsampling and dilated convolution are performed.

In some embodiments, the performing feature reconstruction on the subband signal feature through the second neural network model to obtain the estimated subband signal corresponding to the subband signal feature includes: performing the following processing on the subband signal feature through the second neural network model: performing convolution on the subband signal feature to obtain a convolution feature of the subband signal feature; upsampling the convolution feature to obtain an upsampling feature of the subband signal feature; performing pooling on the upsampling feature to obtain a pooling feature of the subband signal feature; and performing convolution on the pooling feature to obtain the estimated subband signal corresponding to the subband signal feature.

As shown in FIG. 12, based on a subband signal feature F′₁(n), a neural network model (a first channel) shown in FIG. 12 is called to generate a low-frequency subband signal x′₁(n). First, convolution is performed on the input low-frequency feature vector F′₁(n) through causal convolution to obtain a 192×1 convolution feature. Then the 192×1 convolution feature is upsampled to obtain a 24×80 upsampling feature. Then pooling (namely, post-processing) is performed on the 24×80 upsampling feature to obtain a 24×160 pooling feature. Finally, convolution is performed on the pooling feature through causal convolution again to obtain a 160-dimensional subband signal x′₁(n).

In some embodiments, the upsampling is implemented through a plurality of concatenated decoding layers; and the upsampling the convolution feature to obtain the upsampling feature of the subband signal feature includes: upsampling the convolution feature through the first decoding layer of the plurality of concatenated decoding layers; outputting an upsampling result of the first decoding layer to a subsequent concatenated decoding layer, and continuing to perform upsampling and output an upsampling result through the subsequent concatenated decoding layer, until the last decoding layer performs output; and using an upsampling result outputted by the last decoding layer as the upsampling feature of the subband signal feature.

As shown in FIG. 12, the convolution feature is upsampled through three concatenated encoding blocks (namely, decoding layers) with different upsampling factors (Up_factor). In some embodiments, the 192×1 convolution feature is first upsampled through a decoding block with an Up_factor of 8 to obtain a 96×8 upsampling result. Then the 96×8 upsampling result is upsampled through a decoding block with an Up_factor of 5 to obtain a 48×40 upsampling results. Finally, the 48×40 upsampling result is upsampled through a decoding block with an Up_factor of 4 to obtain the 24×80 upsampling feature. The decoding block with an Up_factor of 4 is used as an example. Pooling may be first performed based on the Up_factor. Then one or more dilated convolutions are performed, to implement a function of upsampling.

After processing is performed through a decoding layer, an understanding of the upsampling feature is further deepened. When learning is performed through a plurality of decoding layers, the upsampling feature can be accurately learned step by step. The upsampling feature with progressive precision can be obtained through concatenated decoding layers.

In some embodiments, the performing signal decompression on each subband signal feature to obtain the estimated subband signal corresponding to each subband signal feature includes: separately performing feature reconstruction on the first k subband signal features of the N subband signals to obtain estimated subband signals respectively corresponding to the first k subband signal features; and separately performing inverse processing of bandwidth extension on the last N−k subband signal features of the N subband signals to obtain estimated subband signals respectively corresponding to the last N−k subband signal features, k being an integer within a value range of 1<k<N.

In some embodiments, for example, in a case that the encoder side performs feature extraction on the first k subband signals to obtain subband signal features and performs bandwidth extension on the last N−k subband signals, the decoder side separately performs feature reconstruction on the first k subband signal features to obtain estimated subband signals respectively corresponding to the first k subband signal features, and separately performs inverse processing of bandwidth extension on the last N−k subband signal features to obtain estimated subband signals respectively corresponding to the last N−k subband signal features.

In some embodiments, the separately performing inverse processing of bandwidth extension on the last N−k subband signal features to obtain the estimated subband signals respectively corresponding to the last N−k subband signal features includes: performing the following processing on each of the last N−k subband signal features: performing signal synthesis on estimated subband signals associated with the subband signal feature among the first k estimated subband signals to obtain a low-frequency subband signal corresponding to the subband signal feature; performing frequency domain transform based on a plurality of sample points included in the low-frequency subband signal to obtain transform coefficients respectively corresponding to the plurality of sample points; performing spectral band replication on the last half of transform coefficients respectively corresponding to the plurality of sample points to obtain reference transform coefficients of a reference high-frequency subband signal; performing gain processing on the reference transform coefficients of the reference subband signal based on a subband spectral envelope corresponding to the subband signal feature to obtain gain-processed reference transform coefficients; and performing inverse frequency domain transform on the gain-processed reference transform coefficients to obtain the estimated subband signal corresponding to the subband signal feature.

In some embodiments, when the estimated subband signals associated with the subband signal feature among the first k estimated subband signals are next-layer estimated subband signals corresponding to the subband signal feature, signal synthesis is performed on the estimated subband signals associated with the subband signal feature among the first k estimated subband signals to obtain the low-frequency subband signal corresponding to the subband signal feature. In some embodiments, when the encoder side performs multilayer two-channel subband decomposition on the audio signal to generate subband signals at corresponding layers and performs signal compression on the subband signals at the corresponding layers to obtain a corresponding subband signal feature, signal synthesis needs to be performed on the estimated subband signals associated with the subband signal feature among the first k estimated subband signals to obtain the low-frequency subband signal corresponding to the subband signal feature, so that the low-frequency subband signal and the subband signal feature are at a same layer.

When the low-frequency subband signal and the subband signal feature are at a same layer, frequency domain transform is performed based on the plurality of sample points included in the low-frequency subband signal to obtain the transform coefficients respectively corresponding to the plurality of sample points; spectral band replication is performed on the last half of transform coefficients respectively corresponding to the plurality of sample points to obtain reference transform coefficients of a reference high-frequency subband signal; gain processing is performed on the reference transform coefficients of the reference subband signal based on a subband spectral envelope corresponding to the subband signal feature to obtain gain-processed reference transform coefficients; and inverse frequency domain transform is performed on the gain-processed reference transform coefficients to obtain the estimated subband signal corresponding to the subband signal feature.

A frequency domain transform method in some embodiments includes modified discrete cosine transform (MDCT), discrete cosine transform (DCT), and fast Fourier transform (FFT). A frequency domain transform manner is not limited herein.

In some embodiments, the performing gain processing on the reference transform coefficients of the reference subband signal based on the subband spectral envelope corresponding to the subband signal feature to obtain the gain-processed reference transform coefficients includes: dividing the reference transform coefficients of the reference subband signal into a plurality of subbands based on the subband spectral envelope corresponding to the subband signal feature; and performing the following processing on each of the plurality of subbands: determining first average energy corresponding to the subband in the subband spectral envelope, and determining second average energy corresponding to the subband; determining a gain factor based on a ratio of the first average energy to the second average energy; and multiplying the gain factor with each reference transform coefficient included in the subband to obtain the gain-processed reference transform coefficients.

In some embodiments, in a case that a bitstream is received, entropy decoding is first performed. Through lockup of a quantization table, feature vectors F′ₖ(n), k=1, 2 and F′_{HB}(n), namely, the subband signal feature, in three channels are obtained. F′ₖ(n), k=1, 2 and F′_{HB}(n) are arranged based on a binary tree form shown in FIG. 8C. F′ₖ(n), k=1, 2 is at a next layer of F′_{HB}(n). The feature vector F′ₖ(n), k=1, 2 is obtained based on decoding. Refer to a first channel and a second channel in FIG. 12. Estimated values x′_{2,1}(n) and x′_{2,2}(n) of two subband signals are obtained. Dimensionality of x′_{2,1}(n) and x′_{2,2}(n) is 160. x′_{2,1}(n) and x′_{2,2}(n) are at a next layer of F′_{HB}(n).

Based on x′_{2,1}(n) and x′_{2,2}(n), two-channel QMF synthesis filtering is called once to generate an estimated value x′_{LB}(n) of the low-frequency subband signal corresponding to 0-8 kHz, referred to as the low-frequency subband signal for short, with a dimensionality of 320. The low-frequency subband signal x′_{LB}(n) and the subband signal feature F′_{HB}(n) are at a same layer. x′_{LB}(n) is intended for subsequent bandwidth extension to 8-16 kHz.

A process of bandwidth extension to 8-16 kHz is implemented based on eight subband spectral envelopes (namely, F′_{HB}(n)) obtained by decoding the bitstream, and the estimated value x′_{LB}(n), locally generated by the decoder side, of the low-frequency subband signal at 0-8 kHz. An inverse process of the bandwidth extension process is as follows:

MDCT transform for 640 points similar to that on the encoder side is also performed on the low-frequency subband signal x′_{LB}(n) generated on the decoder side to generate MDCT coefficients for 320 points (namely, MDCT coefficients for a low-frequency part). In some embodiments, frequency domain transform is performed based on the plurality of sample points included in the low-frequency subband signal to obtain the transform coefficients respectively corresponding to the plurality of sample points.

Then the MDCT coefficients, generated based on x′_{LB}(n), for the 320 points are copied to generate MDCT coefficients for a high-frequency part (in some embodiments, the reference transform coefficients of the reference subband signal). With reference to a basic feature of a speech signal, the low-frequency part has more harmonics, and the high-frequency part has less harmonics. Therefore, to prevent simple replication from causing excessive harmonics in a manually generated MDCT spectrum for the high frequency part, the last 160 points, in the MDCT coefficients for the 320 points, on which the low-frequency subband depends may serve as a master copy, and the spectrum is copied twice to generate reference values of MDCT coefficients of the reference subband signal for 320 points (namely, the reference transform coefficients for the reference subband signal). In some embodiments, spectral band replication is performed on the last half of the transform coefficients respectively corresponding to the plurality of sample points to obtain the reference transform coefficients of the reference subband signal.

Then the previously obtained eight subband spectral envelopes (in some embodiments, the eight subband spectral envelopes obtained through lookup of the quantization table, namely, the subband spectral envelope F′_{HB}(n) corresponding to the subband signal feature) are called. The eight subband spectral envelopes correspond to eight high-frequency subbands. The generated reference values of the MDCT coefficients of the reference subband signal for 320 points are divided into eight reference subbands (in some embodiments, the reference transform coefficients of the reference subband signal are divided into a plurality of subbands based on the subband spectral envelope corresponding to the subband signal feature). Subbands are distinguished, and gain control (multiplication in frequency domain) is performed on the generated reference values of the MDCT coefficients of the reference subband signal for 320 points based on a high-frequency subband and a corresponding reference subband. For example, a gain factor is calculated based on average energy (namely, the first average energy) of the high-frequency subband and average energy (the second average energy) of the corresponding reference subband signal. An MDCT coefficient corresponding to each point in the corresponding reference subband signal is multiplied by the gain factor to ensure that energy of a virtual high-frequency MDCT coefficient generated during decoding is close to that of an original coefficient on the encoder side.

In some embodiments, for example, it is assumed that average energy of a reference subband, generated through replication, of the reference subband signal is Y_L, and average energy of a current high-frequency subband on which gain control is performed (namely, a high-frequency subband corresponding to a subband spectral envelope obtained by decoding the bitstream) is Y_H. In this case, a gain factor is calculated as follows: a=sqrt(Y_H/Y_L). After the gain factor a is obtained, each point, generated through replication, in the reference subband signal is directly multiplied by a.

Finally, inverse MDCT transform is called to generate an estimated value x′_{HB}(n) (namely, the estimated subband signal corresponding to the subband signal feature F′_{HB}(n)) of the subband signal. Inverse MDCT transform is performed on gain-processed MDCT coefficients for 320 points to generate estimated values for 640 points. Through overlapping, estimated values of the first 320 valid points are used as x′_{HB}(n).

When the first k subband signal features and the last N−k subband signal features are at a same layer, bandwidth extension may be directly performed on the last N−k subband signal features based on the estimated subband signals respectively corresponding to the first k subband signal features.

In some embodiments, in a case that a bitstream is received, entropy decoding is first performed. Through lockup of a quantization table, feature vectors F′ₖ(n), k=1, 2,3,4, namely, the subband signal feature, in four channels are obtained. F′ₖ(n), k=1, 2,3,4 are arranged based on a binary tree form shown in FIG. 8B. F′ₖ(n), k=1, 2,3,4 are at a same layer. The feature vector F′ₖ(n), k=1, 2 is obtained based on decoding. Refer to a first channel and a second channel in FIG. 12. Estimated values x′₁(n) and x′₂(n) of two subband signals are obtained. With reference to a basic feature of a speech signal, the low-frequency part has more harmonics, and the high-frequency part has less harmonics. Therefore, to prevent simple replication from causing excessive harmonics in a manually generated MDCT spectrum for the high frequency part, x′₂(n) may be selected to perform bandwidth extension on F′ₖ(n), k=3, 4. An inverse process of bandwidth extension of F′ₖ(n), k=3, 4 is implemented based on x′₂(n) and eight subband spectral envelopes (namely, F′ₖ(n), k=3, 4) obtained by decoding the bitstream. The inverse process of bandwidth extension is similar to the foregoing inverse process of bandwidth extension.

In operation 203, signal synthesis is performed on a plurality of estimated subband signals to obtain a synthetic audio signal corresponding to the plurality of bitstreams.

In some embodiments, the signal synthesis is an inverse process of signal decomposition, and the decoder side performs subband synthesis on the plurality of estimated subband signals to restore the audio signal, where the synthetic audio signal is a restored audio signal.

In some embodiments, the performing signal synthesis on the plurality of estimated subband signals to obtain the synthetic audio signal corresponding to the plurality of bitstreams includes: upsampling the plurality of estimated subband signals to obtain filtered signals respectively corresponding to the plurality of estimated subband signals; and performing filter synthesis on a plurality of filtered signals to obtain the synthetic audio signal corresponding to the plurality of bitstreams.

In some embodiments, after the plurality of estimated subband signals are obtained, subband synthesis is performed on the plurality of estimated subband signals through a QMF synthesis filter to restore the audio signal.

Some embodiments may be applied to various audio scenarios, for example, a voice call or instant messaging. The voice call is used below as an example for description.

A principle of speech encoding in the related art is generally as follows: During speech encoding, speech waveform samples can be directly encoded sample by sample. Related low-dimensionality features are extracted according to a vocalism principle of humans, an encoder encodes these features, and a decoder reconstructs a speech signal based on these parameters.

The foregoing encoding principles are derived from speech signal modeling, namely, a compression method based on signal processing. Compared with the compression method based on signal processing, to improve encoding efficiency while ensuring speech quality, some embodiments provide a speech encoding method (namely, an audio processing method) based on multichannel signal decomposition and a neural network. A speech signal with a specific sampling rate is decomposed into a plurality of subband signals based on features of a speech signal. For example, the plurality of subband signals include a subband signal with a low sampling rate and a subband signal with a high sampling rate. Different subband signals may be compressed by using different data compression mechanisms. For an important part (the subband signal with a low sampling rate), a feature vector with lower dimensionality than that of an input subband signal is obtained through processing based on a neural network (NN) technology. For a less important part (the subband signal with a high sampling rate), fewer bits are used for encoding.

Some embodiments may be applied to a speech communication link shown in FIG. 6. A Voice over Internet Protocol (VOIP) conference system is used as an example. A voice codec technology used in some embodiments is deployed in an encoding part and a decoding part to provide basic functions of speech compression. An encoder is deployed on an uplink client 601, and a decoder is deployed on a downlink client 602. The uplink client captures speech, performs preprocessing, enhancement, encoding, and the like, and transmits an encoded bitstream to the downlink client 602 through a network. The downlink client 602 performs decoding, enhancement, and the like to replay decoded speech on the downlink client 602.

Considering forward compatibility (for example, a new encoder is compatible with an existing encoder), a transcoder needs to be deployed in the system background (in some embodiments, on a server) to support interworking between the new encoder and the existing encoder. In some embodiments, in a case that a transmit end (the uplink client) is a new NN encoder and a receive end (the downlink client) is a public switched telephone network (PSTN) (G.722), in the background, an NN decoder needs to run to generate a speech signal, and then a G.722 encoder is called to generate a specific bitstream to implement a transcoding function. In this way, the receive end can correctly perform decoding based on the specific bitstream.

A speech encoding method based on multichannel signal decomposition and a neural network in some embodiments is described below with reference to FIG. 7.

The following processing is performed on an encoder side:

An input speech signal x(n) of an n^{th} frame is decomposed into N subband signals by using a multichannel analysis filter. For example, after a signal is inputted, multichannel QMF decomposition is performed to obtain N subband signals xₖ(n), k=1, 2, . . . , N.

For a k^{th} subband signal xₖ(n), k^{th}-channel analysis is called to obtain a low-dimensionality feature vector Fₖ(n). Dimensionality of the feature vector Fₖ(n) is lower than that of the subband signal xₖ(n). In this way, an amount of data is reduced. For example, for each frame xₖ(n), a dilated convolutional network (dilated CNN) is called to generate a feature vector Fₖ(n) with lower dimensionality. Other NN structures are not limited herein. For example, an autoencoder, a fully connected (FC) network, a long short-term memory (LSTM) network, or a combination of a convolutional neural network (CNN) and LSTM may be used.

For a subband signal with a high sampling rate, considering that the subband signal with a high sampling rate is less important to quality than a low-frequency subband signal, other solutions may be used to extract a feature vector for the subband signal with a high sampling rate. For example, in a bandwidth extension technology based on speech signal analysis, a high-frequency subband signal can be generated at a bitrate of only 1 to 2 kbps.

Vector quantization or scalar quantization is performed on a feature vector corresponding to a subband. Entropy encoding is performed on an index value obtained through quantization, and an encoded bitstream is transmitted to a decoder side.

The following processing is performed on a decoder side:

A bitstream received on the decoder side is decoded to obtain an estimated value F′ₖ(n), k=1, 2, . . . , N of a feature vector for each channel.

k^{th}-channel synthesis is performed on a channel k (namely, F′ₖ(n)) to generate an estimated value x′ₖ(n) of a subband signal.

A QMF synthesis filter is called to generate a reconstructed speech signal x′(n).

QMF filters, a dilated convolutional network, and a bandwidth extension technology are described below before the speech encoding method based on multichannel signal decomposition and a neural network in some embodiments is described.

The QMF filters are a filter pair that includes analysis and synthesis. For the QMF analysis filter, an input signal with a sampling rate of Fs may be decomposed into N subband signals with a sampling rate of Fs/N. FIG. 8A shows spectral response for a low-pass part H_Low(z) (equivalent to H₁(z)) and a high-pass part H_High(z) (equivalent to H₂(z)) of a two-channel QMF filter. Based on related theoretical knowledge of QMF analysis filters, correlation between a low-pass filter coefficient and a high-pass filter coefficient can be easily described, as shown in a formula (1):

$${h}_{High} ( k ) = - {1}^{k} {h}_{Low} ( k ) \qquad ( 1 )$$

h_{Low}(k) indicates a low-pass filter coefficient, and h_{High}(k) indicates a high-pass filter coefficient.

Similarly, according to a QMF related theory, QMF synthesis filters may be described based on the QMF analysis filters H_Low(z) and H_High(z), as shown in a formula (2):

$${G}_{Low} ( z ) = {H}_{Low} ( z ) \\ {G}_{High} ( z ) = ( - 1 ) * {H}_{High} ( z ) \qquad ( 2 )$$

G_{Low}(z) indicates a restored low-pass signal, and G_{High}(z) indicates a restored high-pass signal.

A reconstructed signal, with a sampling rate of Fs, that corresponds to the input signal may be restored through synthesis performed by QMF synthesis filters on the low-pass signal and the high-pass signal that are restored on a decoder side.

In some embodiments, based on the foregoing two-channel QMF solution, an N-channel QMF solution may be further obtained through extension. For example, two-channel QMF analysis may be iteratively performed on a current subband signal by using a binary tree to obtain a subband signal with a lower resolution. FIG. 8B shows that a four-channel subband signal may be obtained by using a two-channel QMF analysis filter with two layers of iterations. FIG. 8C shows another implementation. Considering that a high-frequency signal has little impact on quality and does not require high-precision analysis, high-pass filtering needs to be performed on an original signal only once. Similarly, more channels may be implemented, for example, 8, 16, or 32 channels. Details are not described herein.

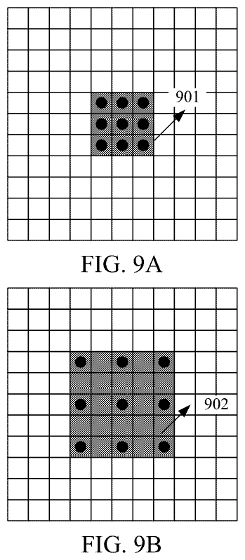

FIG. 9A is a schematic diagram of a common convolutional network according to some embodiments. FIG. 9B is a schematic diagram of a dilated convolutional network according to some embodiments. Compared with the common convolutional network, dilated convolution can expand a receptive field while keeping a size of a feature map unchanged, and can also avoid errors caused by upsampling and downsampling. Kernel sizes shown in FIG. 9A and FIG. 9B are both 3×3. However, a receptive field 901 for common convolution in FIG. 9A is only 3, while a receptive field 902 for dilated convolution in FIG. 9B reaches 5. In some embodiments, for a convolution kernel with a size of 3×3, the receptive field for common convolution in FIG. 9A is 3, and a dilation rate (the number of intervals between points in the convolution kernel) is 1; and the receptive field for dilated convolution in FIG. 9B is 5, and a dilation rate is 2.

The convolution kernel may be further shifted on a plane similar to that shown in FIG. 9A or FIG. 9B. Herein, a concept of stride rate (step) is used. For example, the convolution kernel is shifted by 1 grid each time. In this case, a corresponding stride rate is 1.

In some embodiments, a concept of convolution channel quantity may be further used, which indicates the number of convolution kernels whose parameters are to be used for convolutional analysis. Theoretically, a larger number of channels results in more comprehensive analysis of a signal and higher accuracy. However, a larger number of channels also leads to higher complexity. For example, a 24-channel convolution operation may be used for a 1×320 tensor, and a 24×320 tensor is outputted.

The kernel size (for example, for a speech signal, the kernel size may be set to 1×3), the dilation rate, the stride rate, and the channel quantity for dilated convolution may be defined according to a practical application requirement. This is not specifically limited herein.

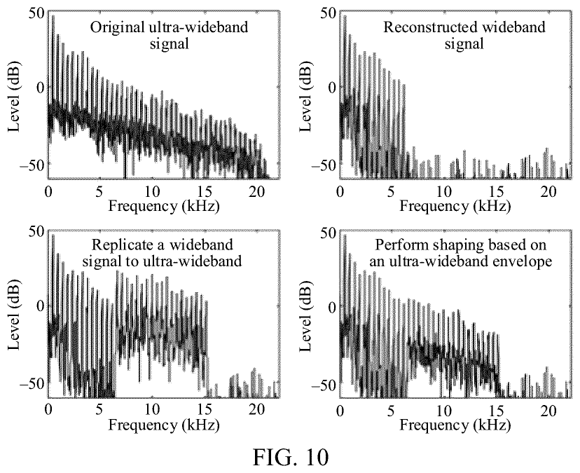

In a diagram of bandwidth extension (or spectral band replication) shown in FIG. 10, a wideband signal is first reconstructed. Then the wideband signal is replicated to an ultra-wideband signal. Finally, shaping is performed based on an ultra-wideband envelope. A frequency-domain implementation solution shown in FIG. 10 may include the following operations: (1) Core layer encoding is implemented at a low sampling rate. (2) A spectrum of a low frequency part is selected and replicated to a high frequency. (3) Gain control is performed on a replicated high-frequency spectrum based on pre-recorded boundary information (which describes correlation between high frequency energy and low frequency energy, and the like). A sampling rate can be doubled at a bitrate of only 1 to 2 kbps.

The speech codec method based on subband decomposition and a neural network in some embodiments is described below. In some embodiments, a speech signal with a sampling rate Fs of 32,000 Hz is used as an example. (the method provided in some embodiments is also applicable to scenarios with other sampling rates, including but not limited to 8,000 Hz, 32,000 Hz, and 48,000 Hz). In addition, assuming that a frame length is set to 20 ms, Fs=32000 Hz is equivalent to that each frame includes 640 sample points.

With reference to a flowchart shown in FIG. 7, detailed descriptions are provided for an encoder side and a decoder side in two implementations. A first implementation is as follows:

A process on the encoder side is as follows:

### 1. An Input Signal is Generated.

For a speech signal with a sampling rate Fs of 32,000 Hz, an input signal of an n^{th} frame includes 640 sample points, and is denoted as an input signal x(n).

### 2. QMF Signal Decomposition is Performed.

A QMF analysis filter (two-channel QMF) is called for downsampling. As shown in FIG. 8B, four-channel decomposition is implemented through the QMF analysis filter, and finally, four subband signals can be obtained: xₖ(n), n=1, 2,3,4. Effective bandwidth for the subband signals is 0-4 kHz, 4-8 kHz, 8-12 kHz, and 12-16 kHz respectively. Each frame of subband signal has 160 sample points.

3. k^{th}-Channel Analysis is Performed on the Subband Signal xₖ(n).

For any channel analysis, a deep network (namely, a neural network) is called to analyze the subband signal xₖ(n) to generate a feature vector Fₖ(n) with lower dimensionality. In some embodiments, for a four-channel QMF filter, dimensionality of xₖ(n) is 160, and a feature vector of an output subband signal may be set separately based on a channel to which the subband signal belongs. From the perspective of a data amount, the channel analysis implements functions of “dimensionality reduction” and data compression.

Refer to a diagram of a network structure for channel analysis in FIG. 11. The first channel is used as an example below to describe a detailed process of channel analysis:

First, 24-channel causal convolution is called to expand an input tensor (namely, vector) to be a 24×320 tensor.

Then the 24×320 tensor is preprocessed. For example, a pooling operation with a factor of 2 and an activation function of ReLU is performed on the 24×320 tensor to generate a 24×160 tensor.

Then three encoding blocks with different downsampling factors (Down_factor) are concatenated. An encoding block with a Down_factor of 4 is used as an example. One or more dilated convolutions may be first performed. Each convolution kernel has a fixed size of 1×3, and a stride rate is 1. In addition, dilation rates of the one or more dilated convolutions may be set according to a requirement, for example, may be 3. Certainly, dilation rates of different dilated convolutions are not limited herein. Then Down_factors of the three encoding blocks are set to 4, 5, and 8. This is equivalent to setting pooling factors with different values for downsampling. Channel quantities for the three encoding blocks are set to 48, 96, and 192. Therefore, the 24×160 tensor is converted into a 48×40 tensor, a 96×8 tensor, and a 192×1 tensor sequentially after passing through the three encoding blocks.

Causal convolution similar to preprocessing may be further performed on the 192×1 tensor to output a 32-dimensional feature vector.

As shown in FIG. 11, a network result for a channel corresponding to a higher frequency is simpler. This is reflected by the number of channels of encoding blocks and dimensionality of an output feature vector. A reason mainly lies in that a high frequency part has less impact on quality, and there is no need to extract feature vectors of high-precision and high-dimensionality subband signals as that for the first channel.

As shown in FIG. 11, after four-channel analysis, feature vectors of corresponding subband signals in four channels are obtained: {F₁(n), F₂(n), F₃(n),F₄(n)}, with a dimensionality of 32, 16, 16, and 8 respectively. It can be learned that dimensionality of an original input signal is 640, and total dimensionality of all output feature vectors is only 72. An amount of data is significantly reduced.

(4) Quantization encoding is performed.

Scalar quantization (each component is quantized separately) and entropy encoding may be performed on a four-channel feature vector. In addition, a combination of the vector quantization (a plurality of adjacent components are combined into a vector for joint quantization) and entropy encoding technologies is not limited herein.

After quantization encoding is performed on the feature vector, a corresponding bitstream may be generated. Based on experiments, high-quality compression can be implemented for a 32 kHz ultra-wideband signal at a bitrate of only 6 to 10 kbps.

A process on the decoder side is as follows:

### 1. Quantization Decoding is Performed.

The quantization decoding is an inverse process of quantization encoding. In a case that a bitstream is received, entropy decoding is first performed. Through lockup of a quantization table, estimated values F′ₖ(n), k=1, 2,3,4 of feature vectors in four channels are obtained.

2. k^{th}-Channel Synthesis is Performed on the Estimated Value F′ₖ(n) of the Feature Vector.

The k^{th}-channel synthesis is intended to call a deep neural network model (as shown in FIG. 12) based on the estimated value F′ₖ(n), k=1, 2,3,4 of the feature vector to generate an estimated value x′ₖ(n), k=1, 2,3,4 of the subband signal.

As shown in FIG. 12, a flowchart of a network structure for channel synthesis is similar to that of a network structure of an analysis network. For example, a post-processing structure in a network structure for causal convolution and channel synthesis is similar to a preprocessing structure in the network structure of the analysis network. A structure of a decoding block is symmetric with that of an encoding block on the encoder side. For the encoding block on the encoder side, dilated convolution is first perform, and then pooling and downsampling are performed. For the decoding block on the decoder side, pooling is first performed, and then upsampling and dilated convolution are performed.

### 3. Synthesis Filter

After estimated values x′ₖ(n), k=1, 2,3,4 of subband signals in four channels are obtained on the decoder side, only a four-channel QMF synthesis filter (as shown in FIG. 8B) needs to be called to generate a reconstructed signal x′(n) including 640 points.

A second implementation is as follows:

The second implementation is mainly intended to simplify a compression process for two high-frequency-related subband signals. As described above, the third channel and the fourth channel in the first implementation correspond to 8-16 kHz (8-12 kHz and 12-16 kHz) and include 24-dimensional feature vectors (a 16-dimensional feature vector and an 8-dimensional feature vector). Based on a basic feature of a speech signal, a simpler technology such as bandwidth extension can be used at 8-16 kHz, so that an encoder side extracts feature vectors with fewer dimensions. This saves bits and reduces complexity. The following provides detailed descriptions for an encoder side and a decoder side in the second implementation.

A process on the encoder side is as follows:

### 1. An Input Signal is Generated.

For a speech signal with a sampling rate Fs of 32,000 Hz, an input signal of an n^{th} frame includes 640 sample points, and is denoted as an input signal x(n).

### 2. QMF Signal Decomposition is Performed.

A QMF analysis filter (two-channel QMF) is called for downsampling. As shown in FIG. 8C, three-channel decomposition is implemented through the QMF analysis filter, and finally, three subband signals can be obtained: x_{HB}(n), x_{2,1}(n), and x_{2,2}(n).

As shown in FIG. 8C, x_{2,1}(n) and x_{2,2}(n) correspond to a spectrum of 0-4 kHz and a spectrum of 4-8 kHz respectively, and are generated by a two-channel QMF analysis filter with two iterations and are equivalent to x₁(n) and x₂(n) in the first implementation. These two subband signals x_{2,1}(n) and x_{2,2}(n) each include 160 sample points.

As shown in FIG. 8C, for a frequency band of 8-16 kHz frequency band, detailed analysis is not required. Therefore, a high-frequency subband signal x_{HB}(n) can be generated by QMF high-pass filtering needs to be performed on an input only once of the original 32 kHz sampled input signal, and each frame includes 320 sample points.

3. k^{th}-Channel Analysis is Performed on the Subband Signal.

Based on the equivalence described above and the analysis on the two subband signals corresponding to x_{2,1}(n) and x_{2,2}(n), refer to the process for two channels (the first channel and the second channel in FIG. 11) in the first implementation. As a result, feature vectors F₁(n) and F₂(n) of corresponding subband signals are generated, with a dimensionality of 32 and 16 respectively.

For subband signals (including 320 sample points/frames) related to 8-16 kHz, a bandwidth extension method (a wideband speech signal is restored from a narrowband speech signal with a limited frequency band) is used. Application of bandwidth extension in some embodiments is described below in detail:

Modified discrete cosine transform (MDCT) is called for a high-frequency subband signal x_{HB}(n) including 320 points to generate MDCT coefficients for the 320 points. Specifically, in the case of 50% overlapping, an (n+1)^{th} frame of high-frequency data and an n^{th} frame of high-frequency data may be combined (spliced), and MDCT is performed for 640 points to obtain the MDCT coefficients for the 320 points.

The MDCT coefficients for the 320 points are divided into N subbands. The subband herein combines a plurality of adjacent MDCT coefficients into a group, and the MDCT coefficients for the 320 points may be divided into eight subbands. For example, the 320 points may be evenly allocated, in other words, each subband includes a same quantity of points. In some embodiments, the 320 points may be divided unevenly. For example, a lower-frequency subband includes fewer MDCT coefficients (with a higher frequency resolution), and a higher-frequency subband includes more MDCT coefficients (with a lower frequency resolution).

According to the Nyquist sampling theorem (to restore an original signal from a sampled signal without distortion, a sampling frequency should be greater than 2 times the highest frequency of the original signal, and when a sampling frequency is less than 2 times the highest frequency of a spectrum, spectra of signals overlap, or when a sampling frequency is greater than 2 times the highest frequency of the spectrum, spectra of signals do not overlap), the MDCT coefficients for the 320 points represent a spectrum of 8-16 kHz. However, UWB speech communication does not necessarily require a spectrum of 16 kHz. For example, if a spectrum is set to 14 kHz, only MDCT coefficients for the first 240 points need to be considered, and correspondingly, a quantity of subbands may be controlled to be 6.

For each subband, average energy of all MDCT coefficients in the current subband is calculated as a subband spectral envelope (the spectral envelope is a smooth curve passing through principal peak points of a spectrum). For example, the MDCT coefficients included in the current subband are x(n), where n=1, 2, . . . , 40. In this case, average energy is as follows: Y=((x(1)²+x(2)²+ . . . +x(40)²)/40). In a case that MDCT coefficients for the 320 points are divided into eight subbands, eight subband spectral envelopes may be obtained. The eight subband spectral envelopes are a generated feature vector FHB(n) of the high-frequency subband signal x_{HB}(n).

To sum up, in either of the foregoing methods (NN structure and bandwidth extension), a 320-dimensional subband signal can be output as an 8-dimensional feature vector. Therefore, high-frequency information can be represented by only a small amount of data. This significantly improves encoding efficiency.

### 4. Quantization Encoding is Performed.

Scalar quantization (each component is quantized separately) and entropy encoding may be performed on the feature vectors (32-dimensional, 16-dimensional, and 8-dimensional) of the foregoing three subband signals. In addition, a combination of the vector quantization (a plurality of adjacent components are combined into a vector for joint quantization) and entropy encoding technologies is not limited thereto.

After quantization encoding is performed on the feature vector, a corresponding bitstream may be generated. Based on experiments, high-quality compression can be implemented for a 32 kHz ultra-wideband signal at a bitrate of only 6 to 10 kbps.

A process on the decoder side is as follows:

### 1. Quantization Decoding is Performed.

The quantization decoding is an inverse process of quantization encoding. In a case that a bitstream is received, entropy decoding is first performed. Through lockup of a quantization table, estimated values F′ₖ(n), k=1, 2 and F′_{HB}(n) of feature vectors in three channels are obtained.

### 2. Channel Synthesis is Performed on the Estimated Values of the Feature Vectors.

For two channels related to 0-8 kHz, the estimated value F′ₖ(n), k=1, 2 of the feature vector may be obtained based on decoding. Refer to related operations in the first implementation (refer to a first channel and a second channel in FIG. 12). Estimated values x′_{2,1}(n) and x′_{2,2}(n) of two subband signals are obtained. Dimensionality of x′_{2,1}(n) and x′_{2,2}(n) is 160.

Based on x′_{2,1}(n) and x′_{2,2}(n), two-channel QMF synthesis filtering is called once to generate an estimated value x′_{LB}(n) of the subband signal corresponding to 0-8 kHz, with a dimensionality of 320. x′_{LB}(n) is intended for subsequent bandwidth extension to 8-16 kHz.

As shown in FIG. 12, a flowchart of a network structure for channel synthesis is similar to that of a network structure of an analysis network. For example, a post-processing structure in a network structure for causal convolution and channel synthesis is similar to a preprocessing structure in the network structure of the analysis network. A structure of a decoding block is symmetric with that of an encoding block on the encoder side. For the encoding block on the encoder side, dilated convolution is first perform, and then pooling and downsampling are performed. For the decoding block on the decoder side, pooling is first performed, and then upsampling and dilated convolution are performed.

A process of channel synthesis at 8-16 kHz is implemented based on eight subband spectral envelopes (namely, F′_{HB}(n)) obtained by decoding the bitstream, and the estimated value x′_{LB}(n), locally generated by the decoder side, of the subband signal at 0-8 kHz. A specific channel synthesis process is as follows:

MDCT transform for 640 points similar to that on the encoder side is also performed on the estimated value x′_{LB}(n) of the low-frequency subband signal generated on the decoder side to generate MDCT coefficients for 320 points (namely, MDCT coefficients for a low-frequency part).

The MDCT coefficients, generated based on x′_{LB}(n), for the 320 points are copied to generate MDCT coefficients for a high-frequency part. With reference to a basic feature of a speech signal, the low-frequency part has more harmonics, and the high-frequency part has less harmonics. Therefore, to prevent simple replication from causing excessive harmonics in a manually generated MDCT spectrum for the high frequency part, the last 160 points, in the MDCT coefficients for the 320 points, on which the low-frequency subband depends may serve as a master copy, and the spectrum is copied twice to generate reference values of MDCT coefficients of the high-frequency subband signal for 320 points.

The previously obtained eight subband spectral envelopes (in some embodiments, the eight subband spectral envelopes obtained through lookup of the quantization table) are called. The eight subband spectral envelopes correspond to eight high-frequency subbands. The generated reference values of the MDCT coefficients of the high-frequency subband signal for 320 points are divided into eight reference high-frequency subbands. Subbands are distinguished, and gain control (multiplication in frequency domain) is performed on the generated reference values of the MDCT coefficients of the high-frequency subband signal for 320 points based on a high-frequency subband and a corresponding reference high-frequency subband. For example, a gain factor is calculated based on average energy of the high-frequency subband and average energy of the corresponding reference high-frequency subband. An MDCT coefficient corresponding to each point in the corresponding reference high-frequency subband is multiplied by the gain factor to ensure that energy of a virtual high-frequency MDCT coefficient generated during decoding is close to that of an original coefficient on the encoder side.

For example, it is assumed that average energy of a high-frequency subband, generated through replication, of the high-frequency subband signal is Y_L, and average energy of a current high-frequency subband on which gain control is performed (namely, a high-frequency subband corresponding to a subband spectral envelope obtained by decoding the bitstream) is Y_H. In this case, a gain factor is calculated as follows: a=sqrt(Y_H/Y_L). After the gain factor a is obtained, each point, generated through replication, in the high-frequency subband is directly multiplied by a.

In some embodiments, inverse MDCT transform is called to generate an estimated value x′_{HB}(n) of the high-frequency subband signal. Inverse MDCT transform is performed on gain-processed MDCT coefficients for 320 points to generate estimated values for 640 points. Through overlapping, estimated values of the first 320 valid points are used as x′_{HB}(n).

### 3. Synthesis Filter

After the estimated value x′_{LB}(n) of the low-frequency subband signal and the estimated value x′_{HB}(n) of the high-frequency subband signal are obtained on the decoder side, upsampling may be performed, and a two-channel QMF synthesis filter may be called once to generate a reconstructed signal x′(n) including 640 points.

In some embodiments, data may be captured for joint training on related networks on an encoder side and a decoder side, to obtain an optimal parameter. A user only needs to prepare data and set a corresponding network structure. After training is completed in the background, a trained model can be put into use.

To sum up, in the speech encoding method based on multichannel signal decomposition and a neural network in some embodiments, signal decomposition, a signal processing technology, and the deep neural network are integrated to significantly improve encoding efficiency compared with a signal processing solution while ensuring audio quality and acceptable complexity.

The audio processing method provided in some embodiments is described with reference to the terminal device provided in some embodiments. Some embodiments provide an audio processing apparatus. In some embodiments, functional modules in the audio processing apparatus may be cooperatively implemented by hardware resources of an electronic device (for example, a terminal device, a server, or a server cluster), for example, computing resources such as a processor, communication resources (for example, being used for supporting various types of communication such as optical cable communication and cellular communication), and a memory. The audio processing device 555 may be software in the form of a program or plug-in, for example, a software module designed by using C/C++, Java, or other programming languages, application software designed by using C/C++, Java, or other programming languages, or a dedicated software module, an application programing interface, a plug-in, a cloud service, or the like in a large software system. The following describes different implementations by using examples.

The audio processing apparatus 555 includes a series of modules, including a decomposition module 5551, a compression module 5552, and an encoding module 5553. The following further describes how the modules in the audio processing apparatus 555 provided in some embodiments cooperate with each other to implement an audio encoding solution.

The decomposition module is configured to perform multichannel signal decomposition on an audio signal to obtain N subband signals of the audio signal, N being an integer greater than 2, and frequency bands of the N subband signals increasing sequentially. The compression module is configured to perform signal compression on each subband signal to obtain a subband signal feature of each subband signal. The encoding module is configured to perform quantization encoding on the subband signal feature of each subband signal to obtain a bitstream of each subband signal.

In some embodiments, the multichannel signal decomposition is implemented through multi-layer two-channel subband decomposition; and the decomposition module is further configured to: perform first-layer two-channel subband decomposition on the audio signal to obtain a first-layer low-frequency subband signal and a first-layer high-frequency subband signal; perform an (i+1)^{th}-layer two-channel subband decomposition on an i^{th}-layer subband signal to obtain an (i+1)^{th}-layer low-frequency subband signal and an (i+1)^{th}-layer high-frequency subband signal, the i^{th}-layer subband signal being an i^{th}-layer low-frequency subband signal, or an i^{th}-layer high-frequency subband signal and an i^{th}-layer low-frequency subband signal, and i being an increasing natural number with a value range of 1≤i<N; and use a last-layer subband signal and a high-frequency subband signal at each layer that has not undergone the two-channel subband decomposition as subband signals of the audio signal.

In some embodiments, the decomposition module is further configured to: sample the audio signal to obtain a sampled signal, the sampled signal including a plurality of sample points obtained through sampling; perform first-layer low-pass filtering on the sampled signal to obtain a first-layer low-pass filtered signal; downsample the first-layer low-pass filtered signal to obtain the first-layer low-frequency subband signal; perform first-layer high-pass filtering on the sampled signal to obtain a first-layer high-pass filtered signal; and downsample the first-layer high-pass filtered signal to obtain the first-layer high-frequency subband signal.

In some embodiments, the compression module is further configured to perform the following processing on each subband signal: calling a first neural network model corresponding to the subband signal; and performing feature extraction on the subband signal through the first neural network model to obtain the subband signal feature of the subband signal, structural complexity of the first neural network model being positively correlated with dimensionality of the subband signal feature of the subband signal.

In some embodiments, the compression module is further configured to perform the following processing on the subband signal through the first neural network model: performing convolution on the subband signal to obtain a convolution feature of the subband signal; performing pooling on the convolution feature to obtain a pooling feature of the subband signal; downsampling the pooling feature to obtain a downsampling feature of the subband signal; and performing convolution on the downsampling feature to obtain the subband signal feature of the subband signal.

In some embodiments, the compression module is further configured to: separately perform feature extraction on the first k subband signals to obtain subband signal features respectively corresponding to the first k subband signals; and separately perform bandwidth extension on the last N−k subband signals to obtain subband signal features respectively corresponding to the last N−k subband signals, k being an integer within a value range of 1<k<N.

In some embodiments, the compression module is further configured to perform the following processing on each of the last N−k subband signals: performing frequency domain transform based on a plurality of sample points included in the subband signal to obtain transform coefficients respectively corresponding to the plurality of sample points; dividing the transform coefficients respectively corresponding to the plurality of sample points into a plurality of subbands; calculate a mean based on a transform coefficient included in each subband, use the mean as average energy corresponding to each subband, and use the average energy as a subband spectral envelope corresponding to each subband; and determining subband spectral envelopes respectively corresponding to the plurality of subbands as the subband signal feature corresponding to the subband signal.

In some embodiments, the compression module is further configured to: obtain a reference subband signal of a reference audio signal, the reference audio signal being an audio signal adjacent to the audio signal, and a frequency band of the reference subband signal being the same as that of the subband signal; and perform, based on a plurality of sample points included in the reference subband signal and the plurality of sample points included in the subband signal, discrete cosine transform on the plurality of sample points included in the subband signal to obtain the transform coefficients respectively corresponding to the plurality of sample points included in the subband signal.

In some embodiments, the encoding module is further configured to: quantize the subband signal feature of each subband signal to obtain an index value of the subband signal feature; and perform entropy encoding on the index value of the subband signal feature to obtain a bitstream of the subband signal.

The audio processing apparatus 556 includes a series of modules, including a decoding module 5554, a decompression module 5555, and a synthesis module 5556. The following further describes how the modules in the audio processing apparatus 556 provided in some embodiments cooperate with each other to implement an audio decoding solution.

The decoding module is configured to perform quantization decoding on N bitstreams to obtain a subband signal feature corresponding to each bitstream, N being an integer greater than 2, and the N bitstreams being obtained by encoding N subband signals that are obtained by performing multichannel signal decomposition on the audio signal. The decompression module is configured to perform signal decompression on each subband signal feature to obtain an estimated subband signal corresponding to each subband signal feature. The synthesis module is configured to perform signal synthesis on a plurality of estimated subband signals to obtain a synthetic audio signal corresponding to the plurality of bitstreams.

In some embodiments, the decompression module is further configured to perform the following processing on each subband signal feature: calling a second neural network model corresponding to the subband signal feature; and performing feature reconstruction on the subband signal feature through the second neural network model to obtain an estimated subband signal corresponding to the subband signal feature, structural complexity of the second neural network model being positively correlated with dimensionality of the subband signal feature.

In some embodiments, the decompression module is further configured to perform the following processing on the subband signal feature through the second neural network model: performing convolution on the subband signal feature to obtain a convolution feature of the subband signal feature; upsampling the convolution feature to obtain an upsampling feature of the subband signal feature; performing pooling on the upsampling feature to obtain a pooling feature of the subband signal feature; and performing convolution on the pooling feature to obtain the estimated subband signal corresponding to the subband signal feature.

In some embodiments, the decompression module is further configured to: separately perform feature reconstruction on the first k subband signal features to obtain estimated subband signals respectively corresponding to the first k subband signal features; and separately perform inverse processing of bandwidth extension on the last N−k subband signal features to obtain estimated subband signals respectively corresponding to the last N−k subband signal features, k being an integer within a value range of 1<k<N.

In some embodiments, the decompression module is further configured to perform the following processing on each of the last N−k subband signal features: performing signal synthesis on estimated subband signals associated with the subband signal feature among the first k estimated subband signals to obtain a low-frequency subband signal corresponding to the subband signal feature; performing frequency domain transform based on a plurality of sample points included in the low-frequency subband signal to obtain transform coefficients respectively corresponding to the plurality of sample points; performing spectral band replication on the last half of transform coefficients respectively corresponding to the plurality of sample points to obtain reference transform coefficients of a reference subband signal; performing gain processing on the reference transform coefficients of the reference subband signal based on a subband spectral envelope corresponding to the subband signal feature to obtain gain-processed reference transform coefficients; and performing inverse frequency domain transform on the gain-processed reference transform coefficients to obtain the estimated subband signal corresponding to the subband signal feature.

In some embodiments, the decompression module is further configured to: divide the reference transform coefficients of the reference subband signal into a plurality of subbands based on the subband spectral envelope corresponding to the subband signal feature; and perform the following processing on each of the plurality of subbands: determining first average energy corresponding to the subband in the subband spectral envelope, and determining second average energy corresponding to the subband; determining a gain factor based on a ratio of the first average energy to the second average energy; and multiplying the gain factor with each reference transform coefficient included in the subband to obtain the gain-processed reference transform coefficients.

In some embodiments, the decoding module is further configured to perform the following processing on each of the N bitstreams: performing entropy decoding on the bitstream to obtain an index value corresponding to the bitstream; and performing inverse quantization on the index value corresponding to the bitstream to obtain the subband signal feature corresponding to the bitstream.

In some embodiments, the synthesis module is further configured to: upsample the plurality of estimated subband signals to obtain filtered signals respectively corresponding to the plurality of estimated subband signals; and perform filter synthesis on a plurality of filtered signals to obtain the synthetic audio signal corresponding to the plurality of bitstreams.

Some embodiments provide a computer program product or a computer program. The computer program product or the computer program includes computer instructions, and the computer instructions are stored in a computer-readable storage medium. A processor of an electronic device reads the computer instructions from the computer-readable storage medium, and the processor executes the computer instructions, so that the electronic device performs the audio processing method according to some embodiments.

Some embodiments provide a computer-readable storage medium, having executable instructions stored therein. When the executable instructions are executed by a processor, the processor is enabled to perform the audio processing method according to some embodiments, for example, the audio processing method shown in FIG. 4 and FIG. 5.

In some embodiments, the computer-readable storage medium may be a memory such as a read only memory (ROM), a random access memory (RAM), an erasable programmable read-only memory (EPROM), an electrically erasable programmable read-only memory (EEPROM), a flash memory, a magnetic memory, an optic disc, or a CD-ROM. may be various devices including one of or any combination of the foregoing memories.

In some embodiments, the executable instructions may be written in a form of a program, software, a software module, a script, or code based on a programming language in any form (including a compiled or interpretive language, or a declarative or procedural language), and may be deployed in any form, including being deployed as a standalone program, or being deployed as a module, a component, a subroutine, or another unit suitable for use in a computing environment.

In some embodiments, the executable instructions may, but not necessarily, correspond to a file in a file system, and may be stored as a part of a file that stores other programs or data, for example, stored in one or more scripts of a Hypertext Markup Language (HTML) document, stored in a single file dedicated for the discussed program, or stored in a plurality of co-files (for example, files that store one or more modules, subroutines, or code parts).

In some embodiments, the executable instructions may be deployed on one computing device for execution, or may be executed on a plurality of computing devices at one location, or may be executed on a plurality of computing devices that are distributed at a plurality of locations and that are interconnected through a communication network.

It may be understood that related data such as user information is involved in some embodiments. When some embodiments are applied to a specific product or technology, user permission or consent is required, and collection, use, and processing of related data need to comply with related laws, regulations, and standards in related countries and regions.

What is claimed is:

1. An audio processing method, performed by an electronic device, comprising:
performing multichannel signal decomposition on an audio signal to obtain N subband signals of the audio signal, frequency bands of the N subband signals increasing sequentially and N being an integer greater than 2;
performing signal compression on each subband signal of the N subband signals to obtain a subband signal feature of each subband signal; and
performing quantization encoding on the subband signal feature of each subband signal to obtain a bitstream of each subband signal.

2. The audio processing method according to claim 1, wherein feature dimensionality of the subband signal feature of the subband signal is not positively correlated with a frequency band of the subband signal, and feature dimensionality of a subband signal feature of an N^{th} subband signal is lower than feature dimensionality of a subband signal feature of the first subband signal.

3. The audio processing method according to claim 1, wherein the multichannel signal decomposition is implemented through multi-layer two-channel subband decomposition and the performing multichannel signal decomposition comprises:
performing first-layer two-channel subband decomposition on the audio signal to obtain a first-layer low-frequency subband signal and a first-layer high-frequency subband signal;
performing an (i+1)^{th}-layer two-channel subband decomposition on an i^{th}-layer subband signal to obtain an (i+1)^{th}-layer low-frequency subband signal and an (i+1)^{th}-layer high-frequency subband signal, the i^{th}-layer subband signal being an i^{th}-layer low-frequency subband signal, or the i^{th}-layer subband signal being an i^{th}-layer high-frequency subband signal and an i^{th}-layer low-frequency subband signal, and i being an increasing natural number with a value range of 1≤i<N; and
determining a last-layer subband signal and a high-frequency subband signal at each layer of the multi-layers that has not undergone the two-channel subband decomposition as subband signals of the audio signal.

4. The audio processing method according to claim 3, wherein performing the first-layer two-channel subband decomposition comprises:
sampling the audio signal to obtain a sampled signal, the sampled signal comprising a plurality of sample points obtained through sampling;
performing first-layer low-pass filtering on the sampled signal to obtain a first-layer low-pass filtered signal;
downsampling the first-layer low-pass filtered signal to obtain the first-layer low-frequency subband signal;
performing first-layer high-pass filtering on the sampled signal to obtain a first-layer high-pass filtered signal; and
downsampling the first-layer high-pass filtered signal to obtain the first-layer high-frequency subband signal.

5. The audio processing method according to claim 1, wherein the performing signal compression on each subband signal comprises:
performing the following processing on each subband signal:
calling a first neural network model corresponding to the subband signal; and
performing feature extraction on the subband signal through the first neural network model to obtain the subband signal feature of the subband signal, structural complexity of the first neural network model being positively correlated with dimensionality of the subband signal feature of the subband signal.

6. The audio processing method according to claim 5, wherein the performing feature extraction on the subband signal through the first neural network model comprises:
performing the following processing on the subband signal through the first neural network model:
performing convolution on the subband signal to obtain a convolution feature of the subband signal;
performing pooling on the convolution feature to obtain a pooling feature of the subband signal;
downsampling the pooling feature to obtain a downsampling feature of the subband signal; and
performing convolution on the downsampling feature to obtain the subband signal feature of the subband signal.

7. The audio processing method according to claim 1, wherein the performing signal compression comprises:
separately performing feature extraction on a first k subband signals of the N subband signals to obtain subband signal features respectively corresponding to the first k subband signals, k being an integer within a value range of 1<k<N; and
separately performing bandwidth extension on a last N−k subband signals of the N subband signals to obtain subband signal features respectively corresponding to the last N−k subband signals.

8. The audio processing method according to claim 7, wherein the separately performing bandwidth extension on the last N−k subband signals of the N subband signals comprises:
performing the following processing on each of the last N−k subband signals:
performing frequency domain transform based on a plurality of sample points comprised in the subband signal to obtain transform coefficients respectively corresponding to the plurality of sample points;
dividing the transform coefficients respectively corresponding to the plurality of sample points into a plurality of subbands;
performing mean processing on a transform coefficient comprised in each subband to obtain average energy corresponding to each subband, and using the average energy as a subband spectral envelope of a corresponding subband; and
determining a subband spectral envelope of each subband as a subband signal feature of the subband signal.

9. The audio processing method according to claim 8, wherein the performing frequency domain transform comprises:
obtaining a reference subband signal of a reference audio signal, the reference audio signal being an audio signal adjacent to the audio signal, and a frequency band of the reference subband signal being the same as that of the subband signal; and
performing, based on a plurality of sample points comprised in the reference subband signal and the plurality of sample points comprised in the subband signal, discrete cosine transform on the plurality of sample points comprised in the subband signal to obtain the transform coefficients respectively corresponding to the plurality of sample points comprised in the subband signal.

10. The audio processing method according to claim 1, wherein the performing quantization encoding comprises:
quantizing the subband signal feature of each subband signal to obtain an index value of the subband signal feature; and
performing entropy encoding on the index value of the subband signal feature to obtain a bitstream of the subband signal.

11. An audio processing apparatus comprising:
at least one memory configured to store program code; and
at least one processor configured to read the program code and operate as instructed by the program code, the program code comprising:
decomposition code configured to cause at least one of the at least one processor to perform multichannel signal decomposition on an audio signal to obtain N subband signals of the audio signal, frequency bands of the N subband signals increasing sequentially and N being an integer greater than 2;
compression code configured to cause at least one of the at least one processor to perform signal compression on each subband signal of the N subband signals to obtain a subband signal feature of each subband signal; and
encoding code configured to cause at least one of the at least one processor to perform quantization encoding on the subband signal feature of each subband signal to obtain a bitstream of each subband signal.

12. The audio processing apparatus according to claim 11, wherein feature dimensionality of the subband signal feature of the subband signal is not positively correlated with a frequency band of the subband signal, and feature dimensionality of a subband signal feature of an N^{th} subband signal is lower than feature dimensionality of a subband signal feature of the first subband signal.

13. The audio processing apparatus according to claim 11, wherein the multichannel signal decomposition is implemented through multi-layer two-channel subband decomposition and the decomposition code is further configured to cause at least one of the at least one processor to:
perform first-layer two-channel subband decomposition on the audio signal to obtain a first-layer low-frequency subband signal and a first-layer high-frequency subband signal;
perform an (i+1)^{th}-layer two-channel subband decomposition on an i^{th}-layer subband signal to obtain an (i+1)^{th}-layer low-frequency subband signal and an (i+1)^{th}-layer high-frequency subband signal, the i^{th}-layer subband signal being an i^{th}-layer low-frequency subband signal, or the i^{th}-layer subband signal being an i^{th}-layer high-frequency subband signal and an i^{th}-layer low-frequency subband signal, and i being an increasing natural number with a value range of 1≤i<N; and
determine a last-layer subband signal and a high-frequency subband signal at each layer of the multi-layers that has not undergone the two-channel subband decomposition as subband signals of the audio signal.

14. The audio processing apparatus according to claim 13, wherein the decomposition code is further configured to cause at least one of the at least one processor to
sample the audio signal to obtain a sampled signal, the sampled signal comprising a plurality of sample points obtained through sampling;
perform first-layer low-pass filtering on the sampled signal to obtain a first-layer low-pass filtered signal;
downsample the first-layer low-pass filtered signal to obtain the first-layer low-frequency subband signal;
perform first-layer high-pass filtering on the sampled signal to obtain a first-layer high-pass filtered signal; and
downsample the first-layer high-pass filtered signal to obtain the first-layer high-frequency subband signal.

15. The audio processing apparatus according to claim 11, wherein the compression code is further configured to cause at least one of the at least one processor to:
perform the following processing on each subband signal:
call a first neural network model corresponding to the subband signal; and
perform feature extraction on the subband signal through the first neural network model to obtain the subband signal feature of the subband signal, structural complexity of the first neural network model being positively correlated with dimensionality of the subband signal feature of the subband signal.

16. The audio processing apparatus according to claim 15, wherein the compression code is further configured to cause at least one of the at least one processor to:
perform the following processing on the subband signal through the first neural network model:
perform convolution on the subband signal to obtain a convolution feature of the subband signal;
perform pooling on the convolution feature to obtain a pooling feature of the subband signal;
downsample the pooling feature to obtain a downsampling feature of the subband signal; and
perform convolution on the downsampling feature to obtain the subband signal feature of the subband signal.

17. The audio processing apparatus according to claim 11, wherein the compression code is further configured to cause at least one of the at least one processor to:
separately perform feature extraction on a first k subband signals of the N subband signals to obtain subband signal features respectively corresponding to the first k subband signals, k being an integer within a value range of 1<k<N; and
separately perform bandwidth extension on a last N−k subband signals of the N subband signals to obtain subband signal features respectively corresponding to the last N−k subband signals.

18. The audio processing apparatus according to claim 17, wherein the compression code is further configured to cause at least one of the at least one processor to:
perform the following processing on each of the last N−k subband signals:
perform frequency domain transform based on a plurality of sample points comprised in the subband signal to obtain transform coefficients respectively corresponding to the plurality of sample points;
divide the transform coefficients respectively corresponding to the plurality of sample points into a plurality of subbands;
perform mean processing on a transform coefficient comprised in each subband to obtain average energy corresponding to each subband, and using the average energy as a subband spectral envelope of a corresponding subband; and
determine a subband spectral envelope of each subband as a subband signal feature of the subband signal.

19. The audio processing apparatus according to claim 18, wherein the compression code is further configured to cause at least one of the at least one processor to:
obtain a reference subband signal of a reference audio signal, the reference audio signal being an audio signal adjacent to the audio signal, and a frequency band of the reference subband signal being the same as that of the subband signal; and
perform, based on a plurality of sample points comprised in the reference subband signal and the plurality of sample points comprised in the subband signal, discrete cosine transform on the plurality of sample points comprised in the subband signal to obtain the transform coefficients respectively corresponding to the plurality of sample points comprised in the subband signal.

20. A non-transitory computer-readable storage medium, storing computer code which, when executed by at least one processor, causes the at least one processor to at least:
perform multichannel signal decomposition on an audio signal to obtain N subband signals of the audio signal, frequency bands of the N subband signals increasing sequentially and N being an integer greater than 2;
perform signal compression on each subband signal of the N subband signals to obtain a subband signal feature of each subband signal; and
perform quantization encoding on the subband signal feature of each subband signal to obtain a bitstream of each subband signal.
